(19) United States
(12) Patent Application Publication
(10) Pub. No.: US 2012/0248724 A1
(43) Pub. Date: Oct. 4, 2012

(54) VEHICLE STEERING DEVICE

(75) Inventors: Katsuji Watanabe, Wako-shi (JP); Kenji Hattori, Wako-shi (JP)

(73) Assignee: HONDA MOTOR CO., LTD., Tokyo (JP)

(21) Appl. No.: 13/434,943

(22) Filed: Mar. 30, 2012

(30) Foreign Application Priority Data
Mar. 31, 2011 (JP) 2011-080651
Apr. 14, 2011 (JP) 2011-090298
Apr. 27, 2011 (JP) 2011-099866

(51) Int. Cl. B62D 3/12

(52) U.S. Cl. 280/93.514

(57) ABSTRACT

A vehicle steering device in which steering torque is transmitted from a steering wheel to steered wheels via a rack-and-pinion mechanism. The steering device comprises a rack shaft in which a rack is formed, two rack support parts positioned to both sides of a longitudinal direction of the rack shaft relative to the position of a pinion, and an urging part positioned between the two rack support parts. The two rack support parts are positioned near each other so as to support only a back surface of the region where the rack is formed in the rack shaft which is positioned in a steering neutral position, the back surface being supported so as to be capable of sliding in the longitudinal direction. The urging part urges the rack shaft in at least a direction other than towards the rack.

### FIELD OF THE INVENTION

The present invention relates to a technique for improving a rack-and-pinion steering device installed in a vehicle.

### BACKGROUND OF THE INVENTION

In a rack-and-pinion steering device, a steering torque generated by the steering of a steering wheel is transmitted from the steering wheel to steered wheels via a rack-and-pinion mechanism. The rack-and-pinion mechanism converts a rotational motion of the steering wheel into a linear motion. One known example of a rack-and-pinion steering device is disclosed in Japanese Patent Application Laid-Open Publication No. 2006-088978 (JP-A 2006-088978), for example.

The rack-and-pinion steering device disclosed in JP-A 2006-088978 has three rack support parts for slidably supporting a rack shaft on which a rack of a rack-and-pinion mechanism is formed. The three rack support parts support the rack shaft slidably in a longitudinal direction. The rack shaft is supported so that a back surface of a region where the rack is formed can be slid in the longitudinal direction by a rack guide.

However, the length of the rack shaft disclosed in JP-A 2006-088978 must be at least twice the range in which the rack moves in a linear direction. Therefore, the rack-and-pinion mechanism inevitably becomes bulky in the longitudinal direction of the rack. The housing for accommodating the rack-and-pinion mechanism also becomes bulky, which is not advantageous in terms of reducing the size and weight of the steering device. Particularly, when such a steering device is installed in a compact car of small width, the steering device is severely restricted in where it can be placed, and the lengths of tie rods connected at both ends of the rack shaft are also restricted. There is yet room for improvement in increasing the degree of freedom in the design of the vehicle.

### SUMMARY OF THE INVENTION

An object of the present invention is to provide a technique whereby a rack-and-pinion steering device can be reduced in size.

According to an aspect of the present invention, there is provided a vehicle steering device in which steering torque generated by the steering of a steering wheel is transmitted from the steering wheel to steered wheels via a rack-and-pinion mechanism, the vehicle steering device comprising a rack shaft in which a rack of the rack-and-pinion mechanism is formed, two rack support parts positioned on both sides of a longitudinal direction of the rack shaft relative to the position of a pinion of the rack-and-pinion mechanism, and an urging part positioned between the two rack support parts; wherein the two rack support parts are positioned near each other so as to support only a back surface of the region where the rack is formed in the rack shaft positioned in a neutral steering position, the back surface being supported to be capable of sliding in the longitudinal direction; and the urging direction of the urging part is set so that the rack shaft is urged to at least a region other than the region where the rack is formed.

In the present invention, the two rack support parts are capable of supporting only the back surface of the region in the rack shaft where the rack is formed, and are positioned near each other. The back surface of the rack shaft does not have a rack. The urging part positioned between the two rack support parts is capable of urging the rack shaft at least in a direction other than towards the rack. In other words, the urging part is capable of pressing the rack shaft towards the pinion and also of pressing (applying precompression to) the back surface of the rack shaft against the rack support parts. A reaction force corresponding to the precompression occurs in the rack support parts. The rack support parts come to support the back surface of the rack shaft. This rack shaft support configuration is equivalent to a support structure in so-called balanced conditions in which “a beam juts out from both sides of two fulcra, and a concentrated load (the reaction force from the pinion) acts on the longitudinal center of this beam.” Thus, the back surface of the rack shaft is reliably supported to be capable of sliding in the longitudinal direction by three points: the pinion and the two rack support parts. Moreover, the rack itself is not supported by (not in contact with) the rack support parts. There is no need to provide separate members for supporting the rack shaft, and the support configuration for supporting the rack shaft can be simplified.

Furthermore, since the two rack support parts are capable of supporting only the back surface of the region in the rack shaft where the rack is formed, the rack support parts can be positioned near each other. Since the rack support parts can be positioned within the range of the rack's length, the entire length of the rack shaft can be shorter than in conventional practice wherein the rack support parts are positioned outside of this range. Therefore, the rack-and-pinion mechanism can be reduced in size in the longitudinal direction of the rack. The tie rods connected to both ends of the rack shaft can be lengthened in proportion to the shortening of the rack shaft. However, the diameters of the tie rods are smaller than the diameter of the rack shaft. Therefore, the total weight of the rack shaft and the tie rods combined is reduced. The housing for accommodating the rack-and-pinion mechanism can also be reduced in size in proportion to the shortening of the rack shaft. Thus, the steering device can be reduced in size and weight, and cost can be reduced as well.

Furthermore, the tie rods connected to the rack shaft can be lengthened in proportion to the amount by which the rack shaft is shorter than in conventional practice. Therefore, the degree of freedom in design can be increased both in the steering device and the vehicle employing the steering device. For example, the degree of freedom in design can be increased in the suspension geometry formed by the tie rods of the steering device and a suspension device. Particularly, the restrictions in placing such a steering device are small when the steering device is installed in a compact car of small width. Moreover, if the tie rods are lengthened, the effect of changes in toe can be suppressed when the left and right steered wheels bump or rebound. As a result, the maneuverability of the vehicle can be increased.

Generally, when long tie rods are used, it is easy to set up a steering geometry whereby the longitudinal force (thrust, axial force) acting on the rack shaft can be reduced, particularly in steering areas having a large steering angle at times such as when the vehicle is steered while stopped (so-called stationary steering). In other words, it is possible to set up a steering geometry such that the thrust acting on the rack shaft can be reduced in steering areas having a large steering angle. The steering torque with which the steering wheel is steered is reduced by reducing the thrust. Since the steering torque remains low, the load of the rack-and-pinion mechanism is reduced. This makes an allowable range possible for the strength and durability of the rack-and-pinion mechanism, and the reliability of the rack-and-pinion mechanism therefore increases.

Moreover, when a so-called electric power steering device is used as the steering device, which is designed so that auxiliary torque generated by an electric motor in accordance with the steering torque is applied to the rack-and-pinion mechanism, the auxiliary torque generated by the electric motor can be reduced in proportion to the reduction in steering torque. Consequently, the electric motor can be reduced in size. Therefore, the weight of the overall steering device can be reduced, and this also contributes to reducing the power consumed by the steering device. The load on the engine is reduced proportionately, and the vehicle employing the steering device has greater fuel efficiency.

Preferably, the urging part is comprised of a rack guide for supporting the back surface of the region of the rack shaft where the rack is formed, the back surface being supported to be capable of sliding in the longitudinal direction; and a compression coil spring for urging the rack guide toward the back surface; wherein the rack guide has a pressing surface for pressing against the back surface; and the pressing surface of the rack guide is formed to be capable of contact with only one of any side of the surfaces of the back surface of the rack shaft relative to a pinion-orthogonal reference line which is orthogonal to a center line of the rack shaft and orthogonal to a center line of the pinion.

Thus, the urging part is configured from the rack guide and the compression coil spring. The pressing surface of the rack guide is not in contact with the entire back surface of the rack shaft, but is formed to be capable of contact with only one side referencing the pinion-orthogonal reference line. By this pressing surface of the rack guide having such a very simple configuration, the rack shaft can be pressed towards the pinion and the back surface of the rack shaft can be pressed against the rack support parts. There is no need to provide separate components in order to press the back surface of the rack shaft against the rack support parts.

Moreover, only one substantial half of the pressing surface of the rack guide is in contact with the back surface of the rack shaft, and the other substantial half equivalent to a conventional rack guide is in contact with the rack support parts. In other words, the friction resistance that has an effect on the rack shaft is equivalent to that of only one conventional rack guide. In a conventional steering device, the friction resistance that has an effect is the combined total of the friction resistance of the rack guide and the friction resistance of the rack support parts supporting the rack shaft in the longitudinal direction. In the steering device of the present invention, since the friction resistance that has an effect is equivalent to that of only one rack guide, the friction resistance when the rack shaft slides can be suppressed.

Preferably, at least the back surface of the rack shaft is formed in a substantially arcuate cross section, the pressing surface of the rack guide is formed in a substantially arcuate cross section along the back surface of the rack shaft, a radius of the arc of the pressing surface of the rack guide is set greater than a radius of the arc of the back surface of the rack shaft, and the center of the pressing surface of the rack guide is offset from the center line of the rack shaft in a face width direction of the rack.

Thus, the radius of the arc of the pressing surface of the rack guide is set greater than the radius of the arc of the back surface of the rack shaft. The center of the pressing surface of the rack guide is offset from the center of the rack shaft in the face width direction of the rack. By this pressing surface of the rack guide having such a very simple configuration, the rack shaft can be pressed towards the pinion and the back surface of the rack shaft can be pressed against the rack support parts. Moreover, there is no need to provide separate support members for supporting the rack shaft.

Preferably, the urging part is comprised of a rack guide for supporting the back surface of the region of the rack shaft where the rack is formed, the back surface being supported to be capable of sliding in the longitudinal direction, and a compression coil spring for urging the rack guide toward the back surface; wherein a center line of the rack guide and a center line of the compression coil spring are inclined in an axial direction of the pinion relative to a pinion-orthogonal reference line which is orthogonal to a center line of the rack shaft and orthogonal to a center line of the pinion.

By the rack guide which has a very simple configuration in which the center line of the rack guide is inclined in the axial direction of the pinion relative to the pinion-orthogonal reference line, the rack shaft can be pressed towards the pinion and the back surface of the rack shaft can be pressed against the rack support parts. Moreover, there is no need to provide separate support members for supporting the rack shaft.

Preferably, the two rack support parts are configured from cylindrical bearings, and a center line of the rack shaft is offset from a center line of the bearings in a direction away from the pinion and along a center line (Pp) of the pinion. Thus, the center line of the rack shaft is offset from the center line of the bearings in a direction away from the pinion and along a center line of the pinion. Therefore, the rack itself can be even more reliably prevented from being supported by (being in contact with) the two bearings.

Preferably, a straight line orthogonal to the center line of the rack shaft and parallel to the center line of the pinion is defined as a pinion-parallel reference line, the two rack support parts are configured from cylindrical bearings, two rack-opposite convex parts capable of being supported by the two bearings are formed on the same periphery of an external peripheral surface of the rack shaft, and the two rack-opposite convex parts are positioned on the side of the pinion-parallel reference line that is opposite of the rack and are also positioned on both sides of the pinion-orthogonal reference line.

The two rack-opposite convex parts are positioned on the side of the pinion-parallel reference line that is opposite of the rack and are also positioned on both sides of the pinion-orthogonal reference line. Furthermore, the center line of the rack guide is inclined in the axial direction of the pinion relative to the pinion-orthogonal reference line. Therefore, the bearings do not support the entire back surface of the rack shaft, but the bearings can support at least one of the two rack-opposite convex parts.

Generally, when the vehicle is steered while traveling, the steering force remains comparatively small because the frictional force between the road surface and the steered wheels is small. When the steering force transmitted from the pinion to the rack is small, a small pressing force presses the back surface of the rack shaft against the bearings. In this case, the rack-opposite convex parts positioned on the side of the pinion-orthogonal reference line opposite the rack guide are supported on the bearings. The support point in the rack shaft that is supported by the bearings is reliably established.

When the steering force transmitted from the pinion to the rack is large, the pressing force whereby the back surface of the rack shaft is pressed against the bearings is also large. In this case, both of the two rack-opposite convex parts positioned on both sides of the pinion-orthogonal reference line are supported on the bearings. Therefore, the durability of the rack shaft and the bearings increases because excessive steering force does not act on a single point of the bearings.

Preferably, two rack-adjacent convex parts capable of being supported by the two bearings are formed on the same periphery of the external peripheral surface of the rack shaft, and the two rack-adjacent convex parts are positioned between the pinion-parallel reference line and the rack and are also positioned on both sides of the pinion-orthogonal reference line.

Consequently, when the vehicle is steered while stopped, or during so-called stationary steering, the frictional force between the road surface and the steered wheels is large. In other words, a greater steering force is needed because the road surface reaction force is large. A greater steering force is transmitted from the pinion to the rack. The rack shaft support configuration is a configuration in which the rack shaft juts out from both sides of the two bearings, and a concentrated load (the pressing force of the pinion) acts in the longitudinal center of the rack shaft. Due to the greater pressing force acting on the longitudinal center of the rack shaft from the pinion, both sides of the rack shaft act as though to flex toward the rack. Therefore, the rack formed in the rack shaft acts as though to contact the bearings. Moreover, since at least one of the two rack-adjacent convex parts comes in contact first with the bearings in this case, the rack does not come in contact with the bearings. Consequently, the rack shaft can slide more smoothly.

Preferably, the rack shaft is configured from a hollow material, and the two rack-opposite convex parts and the two rack-adjacent convex parts are portions formed by extruding the hollow member radially outward from the inside. Consequently, the surfaces of the rack-opposite convex parts and the rack-adjacent convex parts are smoother (their surface roughness is satisfactory). Consequently, it is possible to suppress the friction resistance of the convex parts against the bearings when the rack shaft slides.

Furthermore, the rack-opposite convex parts and the rack-adjacent convex parts are increased in hardness through work hardening by cold forging. It is thereby possible to effectively increase the hardness of only the rack-opposite convex parts and the rack-adjacent convex parts which contact the bearings, i.e., of only the sliding portions. As a result, abrasion caused by sliding can be reduced in the rack-opposite convex parts and the rack-adjacent convex parts.

Preferably, the rack guide further comprises a swing regulator for regulating swinging about the pinion-orthogonal reference line. Consequently, the swinging of the rack guide around the pinion-orthogonal reference line can be regulated by the swing regulator. Therefore, a satisfactory state of contact can be maintained between the back surface of the rack shaft and the pressing surface of the rack guide. Because of this, a satisfactory meshing state can be ensured between the pinion and the rack, and the strength and durability of the pinion and rack are improved. Furthermore, since the meshing state between the pinion and the rack is satisfactory, the friction resistance caused by the meshing can be reduced. As a result, the steering sensation of the steering device can be increased.

Preferably, the rack guide is a circular member centered on the pinion-orthogonal reference line and is accommodated in a rack guide housing, the rack guide housing has a circular supporting hole capable of slidably supporting the rack guide along the pinion-orthogonal reference line, and the swing regulator is configured from at least two convex parts formed in the circumferential direction of an external peripheral surface of the rack guide and capable of contact with an internal peripheral surface of the supporting hole. Thus, the swing regulator is configured from at least two convex parts formed in the circumferential direction of the external peripheral surface of the rack guide. Therefore, the swing regulator can have a very simple configuration.

Preferably, the rack guide is a circular member centered on the pinion-orthogonal reference line and is accommodated in a rack guide housing, the rack guide housing has a circular supporting hole capable of slidably supporting the rack guide along the pinion-orthogonal reference line, and the swing regulator is configured from a liquid packing or another viscoelastic packed bed, which is filled into a gap between an external peripheral surface of the rack guide and an internal peripheral surface of the supporting hole. Thus, the swing regulator is configured from a liquid packing or another viscoelastic packed bed, which is filled into the gap between the external peripheral surface of the rack guide and the internal peripheral surface of the supporting hole. Therefore, the swing regulator can have a very simple configuration.

Preferably, the rack guide is a circular member centered on the pinion-orthogonal reference line, the rack guide being provided with an annular groove for mounting an O ring on an external peripheral surface, and being accommodated in a rack guide housing; the rack guide housing has a circular supporting hole capable of slidably supporting the rack guide along the pinion-orthogonal reference line; the swing regulator is configured from the O ring mounted in the annular groove; and an external peripheral surface of the O ring is in contact throughout the entire periphery with an internal peripheral surface of the supporting hole. Thus, the swing regulator has a configuration in which the O ring is mounted in the annular groove formed in the external peripheral surface of the rack guide. The swing regulator can be configured from a very simple configuration merely in which the O ring is mounted in the annular groove formed in the external peripheral surface of the rack guide.

Preferably, a center of the annular groove is offset from a center line of the rack guide. Consequently, when the rack guide is fitted into the supporting hole, the contact pressure of the O ring against the internal surface of the supporting hole differs depending on the region of the external peripheral surface of the O ring. In other words, the contact pressure differs in the circumferential direction of the O ring. Since the contact pressure differs depending on the region of the external peripheral surface of the O ring, the swinging of the rack guide which is substantially centered on the pinion-orthogonal reference line can be regulated even further.

Preferably, the urging part urges the pinion in a direction of meshing with the rack. Consequently, the rack is pressed against the pinion. The back surface of the rack shaft is reliably supported to be capable of sliding in the longitudinal direction by three points: the pinion and the two rack support parts. Moreover, the rack itself is not supported by the rack support parts. Therefore, there is no need to provide separate support members for supporting the rack shaft, and the support configuration can be simplified.

Preferably, the rack is a spur gear having a tooth trace orthogonal to the rack shaft. The pinion meshing with this rack is a “spur gear.” Alternatively, the pinion can be a “helical gear,” and by inclining the pinion shaft in the longitudinal direction of the rack shaft at an angle equivalent to the helix angle of the “helical gear,” a configuration having essentially the same effect as a “spur gear” can be achieved. Thus, the meshing configuration of the pinion and the rack is essentially the same configuration as the case in which the pinion and the rack are both “spur gears.” Therefore, the direction of the tooth trace of the pinion matches the direction of the tooth trace of the rack.

Consequently, when the rack is subjected to an external force (including vibration) in the direction of the tooth trace of the rack, the rack is readily displaced in the direction of the “tooth trace.” For example, when vibration in the direction of the tooth trace of the rack is transmitted from the exterior to the rack, the rack might vibrate in the direction of the tooth trace. Therefore, it is unlikely that the vibration in the direction of the tooth trace of the rack will be converted to vibration in the rotational direction of the pinion and transmitted to the steering wheel. As a result, the driver experiences a greater steering sensation. The “spur gear” rack works in a direction of regulating the vibration in the rotational direction of the pinion. Therefore, vibration in the rotational direction of the pinion is not readily transmitted to the steering wheel. As a result, the driver experiences a greater steering sensation.

When the rack is a “helical gear,” the teeth are formed at an incline relative to the center line of the rack shaft. Therefore, with any cross section orthogonal to the center line of the rack shaft, part of the cross section will contain the teeth of the rack. In cases in which the rack is a “spur gear,” when cross sections are taken one after another of the rack along the center line of the rack shaft, the tooth tip regions and tooth base regions repeat. In other words, depending on the cross section, there are regions where there is only tooth base and is no tooth tip. The secondary moment of a cross section of a region with only tooth base and no tooth tip is less than the secondary moment of cross sections of other regions. Consequently, the rack shaft as a whole flexes comparatively readily, more so than when the rack is a “helical gear.” Moreover, when an external force (including vibration) in the direction of the tooth trace of the rack acts on the rack as described above, the rack is readily displaced in the direction of the “tooth trace.” Consequently, the back surface of the rack shaft is reliably supported to be capable of sliding in the longitudinal direction by three points: the pinion and the two rack support parts.

Furthermore, since the rack is a “spur gear,” when a large road surface reaction force is applied to the rack shaft during times such as stationary steering, the rack shaft is readily displaced in the direction of the “tooth trace” of the rack (in the face width direction). Therefore, depending on the road surface reaction force, it is possible for the rack shaft to gradually rise along the surfaces of the support holes of the rack support parts. In other words, an indeterminate support structure is configured, in which the support positions where the rack shaft is supported by the rack support parts change according to the extent of the reaction force applied to the rack shaft. Consequently, the rack shaft can be sufficiently supported by three points: the meshing point between the pinion and the rack, and the support points of the rack support parts; and the reaction force can be borne sufficiently and reliably. Moreover, durability is high because the rack support parts support the rack shaft in regions that are most appropriate for the extent of the reaction force.

Furthermore, since the overall length of the rack shaft is short as described above, the pinion can be positioned in the widthwise center of the vehicle. The steering wheel is then positioned off-center to the left or right. In other words, the pinion shaft is inclined in the longitudinal direction of the rack shaft. The inclined direction of the pinion shaft is reversed between a right handwheel and a left handwheel. However, since the rack is a “spur gear,” the inclined direction can be the same with both the right handwheel and the left handwheel. It is easy to manage the quality of the steering device, and productivity increases.

Preferably, the urging part is comprised of a rack guide which is capable of sliding along a pinion-orthogonal reference line orthogonal to a center line of the rack shaft and orthogonal to a center line of the pinion, and which supports the back surface of the region of the rack shaft where the rack is formed, the back surface being supported to be capable of sliding in an longitudinal direction; and a compression coil spring for urging the rack guide toward the back surface; wherein the rack guide has a support surface for supporting the back surface, the support surface of the rack guide is formed to be capable of contact with only one side of the back surface relative to the pinion-orthogonal reference line, and a center line in the sliding direction of the rack guide is offset from the pinion-orthogonal reference line in the direction in which the support surface of the rack guide makes contact with the back surface of the rack shaft.

The two rack support parts are capable of supporting only the back surface of the region in the rack shaft where the rack is formed, and are positioned near each other. The back surface of the rack shaft does not have a rack. The rack guide positioned between the two rack support parts is capable of urging the rack shaft at least in a direction other than towards the rack. In other words, the rack guide is capable of pressing the rack shaft towards the pinion and also of pressing (applying precompression to) the back surface of the rack shaft against the rack support parts. A reaction force corresponding to the precompression occurs in the rack support parts. The rack support parts come to support the back surface of the rack shaft. This rack shaft support configuration is equivalent to a support structure in so-called balanced conditions in which “a beam juts out from both sides of two fulcra, and a concentrated load (the reaction force from the pinion) acts in the longitudinal center of this beam.” Thus, the back surface of the rack shaft is reliably supported to be capable of sliding in the longitudinal direction by three points: the pinion and the two rack support parts. Moreover, the rack itself is not supported by (not in contact with) the rack support parts.

Furthermore, since the two rack support parts are capable of supporting only the back surface of the region in the rack shaft where the rack is formed, the rack support parts can be positioned near each other. Since the rack support parts can be positioned within the range of the rack's length, the entire length of the rack shaft can be shorter than in conventional practice wherein the rack support parts are positioned outside of this range. Therefore, the rack-and-pinion mechanism can be reduced in size in the longitudinal direction of the rack. The housing for accommodating the rack-and-pinion mechanism can also be reduced in size, and the steering device can therefore be reduced in size and weight.

Furthermore, the rack guide has a support surface for supporting the back surface of the rack. This support surface of the rack guide is not in contact with the entire back surface of the rack shaft, but is capable of contact with only one side relative to the pinion-orthogonal reference line. Therefore, the contact surface area of the support surface of the rack guide is small. Moreover, the center line in the sliding direction of the rack guide is offset from the pinion-orthogonal reference line in the direction in which the support surface of the rack guide contacts the back surface of the rack shaft.

As described above, the support surface is in contact with only one side of the back surface relative to the pinion-orthogonal reference line. Nevertheless, when the center line of the sliding direction of the rack guide matches the pinion-orthogonal reference line, there is a wide useless range in which the support surface of the rack guide does not contact the back surface of the rack shaft. The rack guide must be increased in size proportionately.

In the present invention, the center line in the sliding direction of the rack guide is offset from the pinion-orthogonal reference line in the direction in which the support surface of the rack guide contacts the back surface of the rack shaft. Therefore, the useless range in which the support surface of the rack guide does not contact the back surface of the rack shaft can be narrowed. The rack guide can be reduced in size proportionately, and as a result, the weight of the rack guide can therefore be reduced. Thus, the range in which the support surface of the rack guide can contact the back surface of the rack shaft can be ensured, and the rack guide can be reduced in size and weight. Taking into consideration that the rack guide having considerable mass and the compression coil spring having a certain spring constant make up a vibration system, the characteristic frequency (the resonance frequency) of this vibration system increases due to the rack guide being reduced in weight. Therefore, since the rack guide has a greater tendency to mimic the vibration of the rack shaft, a satisfactory meshing state of the rack with the pinion can be sufficiently maintained. Consequently, the friction characteristics between the pinion and the rack are satisfactory, the rack-and-pinion steering device can therefore be steered more smoothly, and as a result, the steering sensation can be increased. Moreover, the strength and durability of the rack-and-pinion mechanism can be increased by ensuring that the satisfactory meshing state between the pinion and the rack can be maintained.

Furthermore, since the center line in the sliding direction of the rack guide is offset from the pinion-orthogonal reference line in the direction in which the support surface of the rack guide contacts the back surface of the rack shaft, there is no danger of the rack guide being assembled facing the wrong direction on the back surface of the rack shaft.

Preferably, a contact region of the support surface of the rack guide on the back surface of the rack shaft is made to extend in a straight line in the longitudinal direction of the rack shaft, and is positioned so that the size of the rack guide reaches a maximum in the longitudinal direction of the rack shaft.

Thus, the contact region of the support surface of the rack guide on the back surface of the rack shaft is made to extend in a straight line in the longitudinal direction of the rack shaft, and is positioned so that the size of the rack guide reaches a maximum in the longitudinal direction of the rack shaft. Therefore, the useless range in which the support surface of the rack guide does not contact the back surface of the rack shaft is narrower than in cases in which the center line in the sliding direction of the rack guide matches the pinion-orthogonal reference line. Consequently, the size of the rack guide can be reduced, and as a result, the weight of the rack guide can therefore be reduced.

Preferably, the rack guide is formed in a circular cross section whose reference is a center line in the sliding direction of the rack guide, and the contact region is positioned on the center line. Thus, the rack guide is formed in a circular cross section whose reference is a center line in the sliding direction of the rack guide, and the contact region is positioned on the center line. Therefore, the useless range in which the support surface of the rack guide does not contact the back surface of the rack shaft is narrower than in cases in which the center line in the sliding direction of the rack guide matches the pinion-orthogonal reference line. Consequently, the size of the rack guide can be reduced, and as a result, the weight of the rack guide can therefore be reduced.

### BRIEF DESCRIPTION OF THE DRAWINGS

Several preferred embodiments of the present invention will be described in detail hereinafter with reference to the accompanying drawings, in which:

FIG. 1 is a schematic view showing a vehicle steering device according to Embodiment 1 of the present invention;

FIG. 2 is a cross-sectional view showing a pinion shaft, a rack-and-pinion mechanism, a rack shaft, and two rack support parts of FIG. 1, as assembled;

FIG. 3 is a cross-sectional view taken along line 3-3 of FIG. 2;

FIG. 4 is a perspective view showing the rack-and-pinion mechanism, the rack shaft, and the two rack support parts of FIG. 2, as assembled;

FIG. 5 is a cross-sectional view taken along line 5-5 of FIG. 2;

FIGS. 6A, 6B, and 6C are views schematically showing a relationship among the rack-and-pinion mechanism, the rack shaft, and the urging part of FIG. 3;

FIG. 7 illustrates an action of the vehicle steering device shown in FIG. 1;

FIG. 8 is a cross-sectional view showing a rack-and-pinion mechanism, a rack shaft, and an urging part of a vehicle steering device, as assembled, according to Embodiment 2;

FIG. 9 is a cross-sectional view showing a relationship between the rack shaft and the rack support parts of FIG. 8;

FIG. 10 is a cross-sectional view showing a rack-and-pinion mechanism, a rack shaft, and an urging part of a vehicle steering device, as assembled, according to Embodiment 3;

FIG. 11 is a cross-sectional view showing a rack-and-pinion mechanism, a rack shaft, and an urging part of a vehicle steering device, as assembled, according to Embodiment 4;

FIG. 12 is a cross-sectional view showing a relationship between a rack shaft and rack support parts of a vehicle steering device, as assembled, according to Embodiment 5;

FIG. 13 is a cross-sectional view showing a rack-and-pinion mechanism, a rack shaft, and an urging part of a vehicle steering device, as assembled, according to Embodiment 6;

FIG. 14 is an enlarged cross-sectional view of the rack shaft of FIG. 13;

FIG. 15 is a cross-sectional view showing a relationship between the rack shaft and the rack support parts of FIG. 13;

FIG. 16 is a perspective view showing a rack shaft of a vehicle steering device according to Embodiment 7;

FIG. 17 is a view showing the steps for manufacturing the rack shaft of FIG. 16;

FIG. 18 is a cross-sectional view showing a pair of secondary-formation split dies for additional forming of the rack shaft composed of a semi-complete product of FIG. 17;

FIG. 19 is a cross-sectional view showing a rack guide of a vehicle steering device according to Embodiment 8, with a swing regulator formed therein;

FIG. 20 is a cross-sectional view showing the rack guide of Embodiment 8 of FIG. 19, as fitted in a rack guide housing;

FIG. 21 is a cross-sectional view showing a rack shaft and a rack guide of a vehicle steering device, as assembled, according to Embodiment 9;

FIG. 22 is a cross-sectional view taken along line 22-22 of FIG. 21;

FIG. 23 is a cross-sectional view showing an O ring provided to a rack guide of a vehicle steering device according to Embodiment 10;

FIG. 24 is a cross-sectional view showing a rack guide of a vehicle steering device of Embodiment 11, wherein an O ring having a center line offset from the center line of the rack guide is fitted in the rack guide;

FIG. 25 is a cross-sectional view showing the rack guide and rack shaft of Embodiment 11 of FIG. 24, as assembled;

FIG. 26 is a cross-sectional view showing a rack-and-pinion mechanism, a rack shaft, and an urging part of a vehicle steering device, as assembled, according to Embodiment 12;

FIG. 27 is a perspective view showing the rack-and-pinion mechanism, the rack shaft, and two rack support parts of FIG. 26, as assembled;

FIG. 28 is a cross-sectional view showing a relationship between the rack shaft and rack support parts of FIG. 27;

FIG. 29 is a view showing an action of the vehicle steering device according to Embodiment 12 of FIG. 26;

FIG. 30 is a cross-sectional view taken along line 30-30 of FIG. 29;

FIG. 31 illustrates an example in which the center line of the rack guide matches a pinion-orthogonal reference line, and Embodiment 12 of FIG. 26 in which the center line of the rack guide is offset from the pinion-orthogonal reference line;

FIG. 32 illustrates an example in which the center line of the rack guide matches the pinion-orthogonal reference line and the back surface of the rack shaft is in contact with two locations on the support surface of the rack guide, and Embodiment 12 in which the center line of the rack guide is offset from the pinion-orthogonal reference line and the back surface of the rack shaft is in contact with one location on the support surface of the rack guide;

FIG. 33 is a cross-sectional view showing a vehicle steering device according to Embodiment 13, as assembled, in which a pinion is urged by an urging part in a direction of meshing with a rack;

FIG. 34 is a cross-sectional view taken along line 34-34 of FIG. 33;

FIG. 35 is a view showing a rack-and-pinion mechanism, a rack shaft, and two rack support parts of Embodiment 13 of FIG. 33, as assembled; and

FIG. 36 is a cross-sectional view showing a relationship between the rack shaft and the rack support parts of the vehicle steering device of Embodiment 13 shown in FIG. 33.

### DETAILED DESCRIPTION OF THE PREFERRED EMBODIMENTS

### Embodiment 1

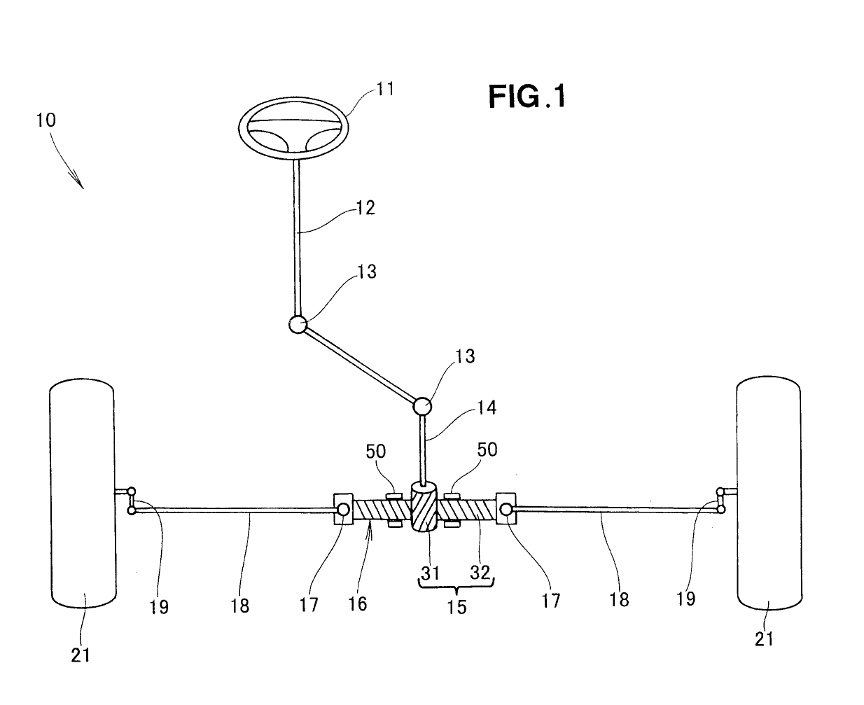

A vehicle steering device according to Embodiment 1 is described based on FIGS. 1 through 7.

The vehicle steering device 10 of Embodiment 1 has a structure in which a pinion shaft 14 (rotating shaft 14) is connected to a steering wheel 11 via a steering shaft 12 and universal joints 13, 13, a rack shaft 16 is connected to the pinion shaft 14 via a rack-and-pinion mechanism 15, and left and right steered wheels 21, 21 are connected to both ends of the rack shaft 16 via ball joints 17,17, tie rods 18, 18, and knuckles 19, 19, as shown in FIG. 1.

With the vehicle steering device 10 (hereinbelow referred to simply as “the steering device 10”), steering torque generated by a driver steering the steering wheel 11 can be transmitted from the steering wheel 11 to the left and right steered wheels 21, 21 via the rack-and-pinion mechanism 15 and the left and right tie rods 18, 18.

The rack-and-pinion mechanism 15 is composed of a pinion 31 formed on the pinion shaft 14 and a rack 32 formed on the rack shaft 16. The pinion 31 and the rack 32 are configured as being a “helical gear.” The pinion shaft 14 extends in the vehicle height direction of the vehicle. The rack shaft 16 is composed of a rod which extends in the vehicle width direction and which is perfectly circular in cross section.

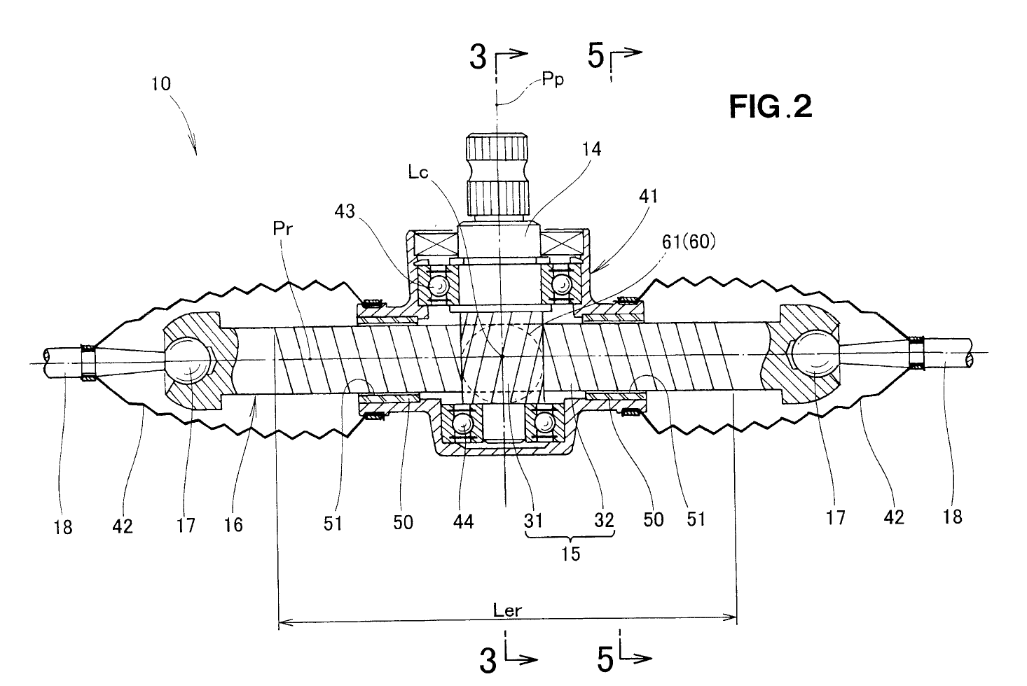

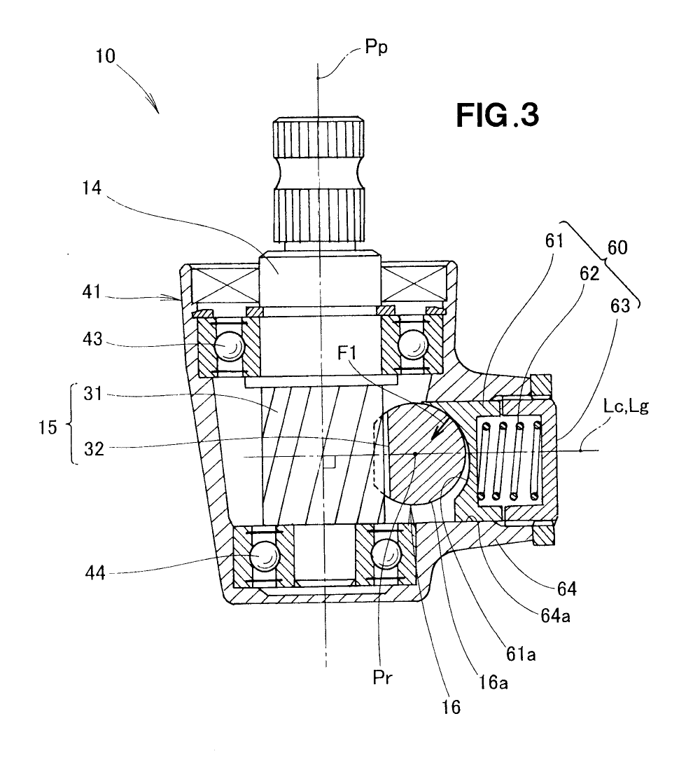

In the rack shaft 16, at least a back surface 16a of the region having the rack 32 formed therein is form a substantially arcuate cross section, as shown in FIGS. 2 and 3. At least the main portion of the pinion shaft 14, the rack-and-pinion mechanism 15, and the rack shaft 16 is accommodated in a housing 41. This housing 41 is a long, thin, cylindrical member extending in the vehicle width direction, and is opened upward through the top end in the longitudinal center. The ends of the rack shaft 16 extend farther outward in the vehicle width direction than the ends of the housing 41. The area between the ends of the housing 41 and the left and right tie rods 18, 18 is covered by boots 42, 42.

The pinion shaft 14 is supported at a top part and bottom end, above and below the pinion 31 by two bearings (an upper first bearing 43 and a lower second bearing 44) attached within the housing 41, so as to be capable of rotating but incapable of axial movement. The two bearings 43, 44 are configured from ball bearings, but the second bearing 44 may be a radial bearing such as a needle bearing.

The steering device 10 comprises two rack support parts 50, 50 to the sides in the longitudinal direction of the rack shaft 16 from the position of the pinion 31 (the position where the pinion 31 and the rack 32 mesh), and an urging part 60 positioned between these two rack support parts 50, 50.

The two rack support parts 50, 50 are members which support the rack shaft 16 as shown in FIGS. 2, 4, and 5, and are configured from cylindrical bearings (e.g., bushes). The rack support parts 50, 50 are attached within the housing 41 by pressure-fitting (interference fitting) or the like, and both have respective perfectly circular support holes 51, 51. The diameters of the support holes 51, 51 are designed to be slightly greater than the diameter of the rack shaft 16. Therefore, the gap between the rack shaft 16 and the support holes 51, 51 is small.

The rack support parts 50, 50 are preferably configured from abrasion-resistant members that have low friction resistance when the rack shaft 16 slides. For example, the rack support parts 50, 50 may be copper-based metal bushes whose surfaces are coated with polytetrafluoroethylene resin (abbrev: PTFE, Teflon (registered trademark)) or another fluororesin.

Furthermore, in cases in which it is acceptable for the rack support parts 50, 50 to have less supporting rigidity for supporting the rack shaft 16 than the copper-based metal, the rack support parts 50, 50 can be configured from a resin product such as a polyacetal resin, a resin containing polyacetal, or a polytetrafluoroethylene resin (abbrev: PTFE, Teflon (registered trademark)) or another fluororesin, for example. The rack support parts 50, 50 can also be configured from resinous bushes capable of elastic deformation, for example. When such resinous bushes are used, the gap between the rack shaft 16 and the support holes 51, 51 can be set to substantially the value of zero.

The length Ler of the rack 32 is set in advance to a certain length taking into account the rotational range of the steering wheel 11 (FIG. 1), e.g., about 3.5 rotations, as shown in FIG. 2. When the rack 32 is positioned in the steering neutral position, the length Ler of the rack 32 is distributed mostly equally between both sides in the axial direction, the reference being the meshing position with the pinion 31. When the rack 32 is positioned in the steering neutral position, the ends of the rack 32 extend farther outward in the vehicle width direction than the ends of the housing 41.

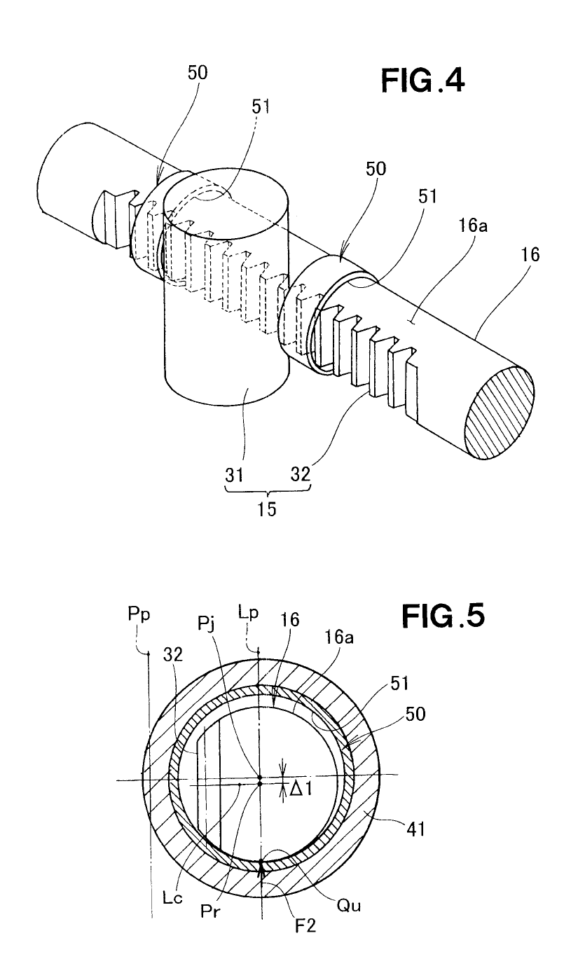

The two rack support parts 50, 50 are positioned near each other so as to support only the back surface 16a of the rack shaft 16 so as to be capable of sliding in the longitudinal direction (the vehicle width direction), the back surface 16a being the region where the rack 32 is formed in the rack shaft 16 positioned in the steering neutral position (the position whereby the vehicle travels directly forward) as shown in FIGS. 2 and 4.

The urging direction of the urging part 60 is set so as to be capable of urging the rack shaft 16 at least in a direction other than towards the rack 32, as shown in FIG. 3. To be specific, the urging part 60 is configured from a rack guide mechanism for performing an action of pressing the rack shaft 16 toward the pinion 31. The urging part 60 (the rack guide mechanism 60) is composed of a rack guide 61 which touches the rack shaft 16 from the side opposite the rack 32, a compression coil spring 62 for urging the rack guide 61 toward the back surface 16a of the rack shaft 16, and an adjusting bolt 63 for pushing on the rack guide 61 via the compression coil spring 62 to adjust the urging force.

The rack guide 61 has a pressing surface 61a (a support surface 61a for supporting the back surface 16a of the rack shaft 16) of the rack guide 61 for pressing against the region of the back surface 16a where the rack 32 is formed in the rack shaft 16. In other words, the rack guide 61 supports the back surface 16a so as to be capable of sliding in the longitudinal direction. The rack guide 61 is composed of an abrasion-resistant material that has low friction resistance; suitable examples include a polyacetal resin, a resin containing polyacetal, a polytetrafluoroethylene resin (abbrev: PTFE, Teflon (registered trademark)) or another fluororesin, and other resin products. It is also possible for only the portion of the rack guide 61 that has the pressing surface 61a of the rack guide 61 to be made of the above-described resin products. The rack guide 61 can also be configured from a sintered metal.

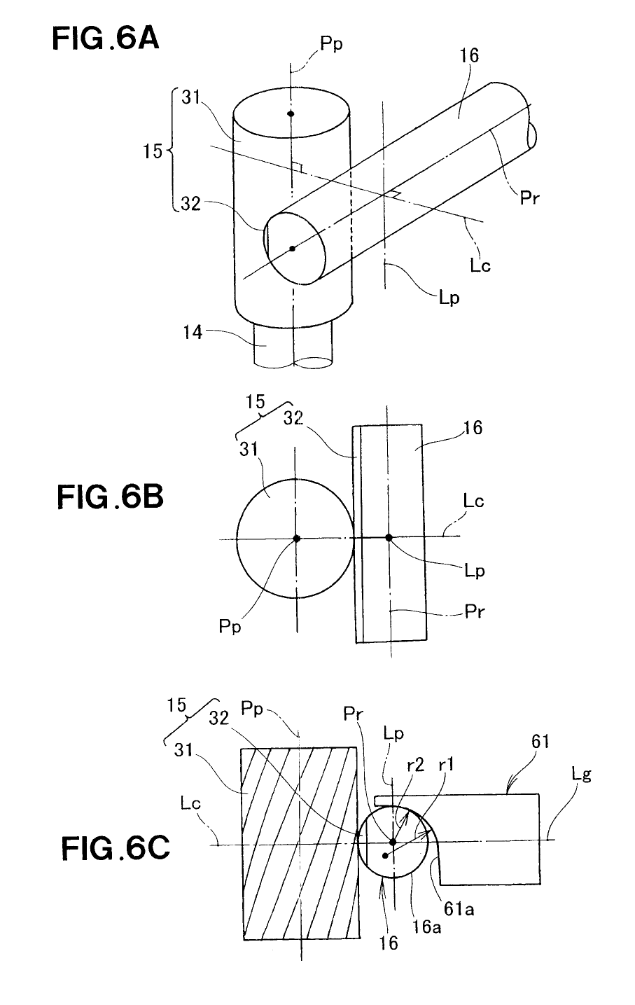

Next, the rack shaft 16 is defined as follows based on FIGS. 6A to 6C. To show the configuration of the vehicle steering device 10 in a simple manner, it is described by FIGS. 6A to 6C in which the pinion shaft 14 and the rack shaft 16 are orthogonal. The same configuration can be used even in cases in which the pinion shaft 14 is inclined relative to the longitudinal direction of the rack shaft 16, i.e., the pinion shaft 14 and the rack shaft 16 intersect at an angle that is not orthogonal.

FIG. 6A is a perspective view schematically depicting the rack-and-pinion mechanism 15 shown in FIG. 2. FIG. 6B is a plan view of the rack-and-pinion mechanism 15 shown in FIG. 6A. FIG. 6C is a cross-sectional view schematically depicting the relationship between the rack-and-pinion mechanism 15 and the rack guide 61 shown in FIG. 2.

A straight line Lc which is orthogonal to both a center line Pr of the rack shaft 16 and a center line Pp of the pinion 31, as shown in FIGS. 6A to 6C, is defined as a “pinion-orthogonal reference line Lc.” A straight line Lp which is orthogonal to the center line Pr of the rack shaft 16 and parallel to the center line Pp of the pinion 31 is defined as a “pinion-parallel reference line Lp.” The pinion-parallel reference line Lp is orthogonal to the pinion-orthogonal reference line Lc.

A center line Lg of the rack guide 61 and a center line Lg of the compression coil spring 62 match the pinion-orthogonal reference line Lc, as shown in FIGS. 3 and 6C. The rack guide 61 is a perfectly circular columnar member centered on the pinion-orthogonal reference line Lc. The rack guide 61 and the compression coil spring 62 are accommodated in a rack guide housing 64. The rack guide housing 64, which is formed integrally in the housing 41, has a circular (perfectly circular) supporting hole 64a which can support the rack guide 61 so as to be capable of sliding along the pinion-orthogonal reference line Lc. The gap between the external peripheral surface of the rack guide 61 and the internal surface of the supporting hole 64a is extremely small while allowing the rack guide 61 to slide.

The pressing surface 61a of the rack guide 61 is formed in a substantially arcuate cross section extending along the back surface 16a of the rack shaft 16. The pressing surface 61a of the rack guide 61 is formed so as to be capable of contact with any one surface of the back surface 16a of the rack shaft 16, relative to the pinion-orthogonal reference line Lc. For example, the pressing surface 61a of the rack guide 61 is capable of contact with either the surface above or the surface below the horizontal pinion-orthogonal reference line Lc.

More specifically, the radius r1 of the arc of the pressing surface 61a of the rack guide 61 is designed to be greater than the radius r2 of the arc of the back surface 16a (r1>r2). The center of the radius r2 of the back surface 16a of the rack shaft 16 is positioned on the pinion-orthogonal reference line Lc. The center of the radius r1 of the arc of the pressing surface 61a of the rack guide 61 is offset either above or below the pinion-orthogonal reference line Lc, i.e., in the face width direction of the rack 32. As a result, the pressing surface 61a of the rack guide 61 contacts the surface of the back surface 16a of the rack shaft 16 that is either above or below the horizontal pinion-orthogonal reference line Lc. In FIGS. 3 and 6C, the pressing surface 61a of the rack guide 61 contacts only the surface of the back surface 16a of the rack shaft 16 that is above the pinion-orthogonal reference line Lc.

A cross-sectional center Pr (a center line Pr) of the rack shaft 16 is offset by an amount Δ1 in the face width direction of the rack 32 from a cross-sectional center Pj (a center line Pj) of the two bearings 50, 50 along a center line Pp of the pinion 31, as shown in FIG. 5. Therefore, the rack shaft 16 has a contact point Qu on the line of action connecting the cross-sectional center Pj of the bearings 50, 50 and the cross-sectional center Pr of the rack shaft 16, i.e., on the pinion-parallel reference line Lp. This contact point Qu is a point where the back surface 16a of the rack shaft 16 contacts the support holes 51, 51 of the bearings. Thus, the contact point Qu of the rack shaft 16 on the support holes 51, 51 of the bearings 50, 50 is in the point of intersection between the pinion-parallel reference line Lp and the support holes 51, 51. The contact point Qu is positioned on the side of the pinion-orthogonal reference line Lc opposite the pressing surface 61a of the rack guide 61, as shown in FIGS. 5 and 6C. In FIG. 5, the contact point Qu is below the pinion-orthogonal reference line Lc. A reaction force F2 occurs from the contact point Qu in the direction of the pinion-parallel reference line Lp. Thus, since the contact point Qu is distanced from (positioned in a region far from) the rack 32, it is possible to more reliably prevent the rack 32 itself from being supported by (from being in contact with) the two bearings 50, 50.

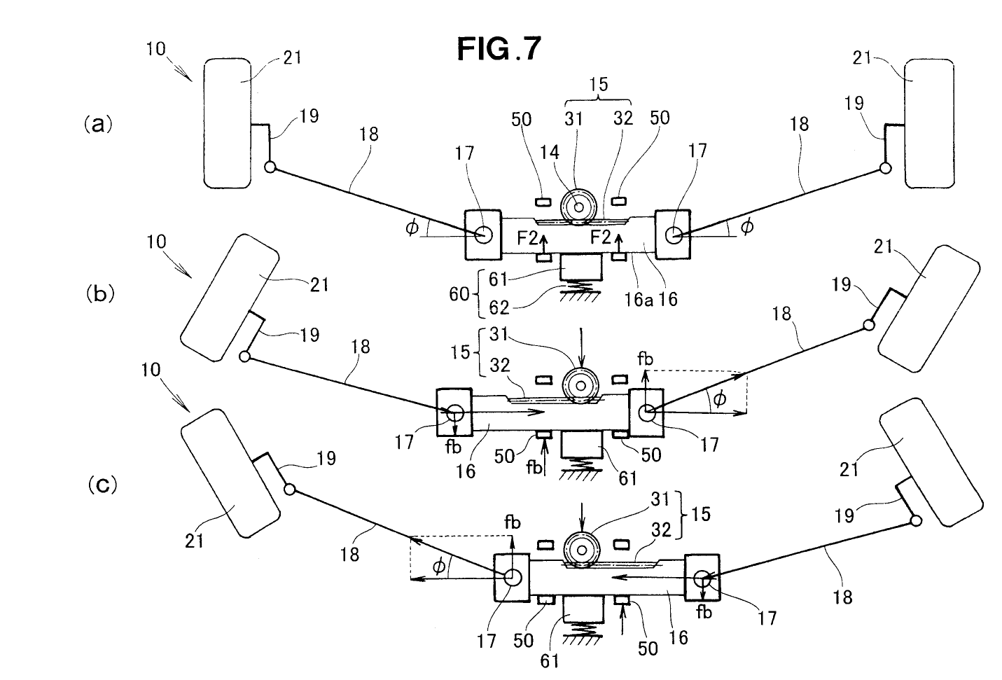

Next, the action of the steering device 10 according to Embodiment 1 is described based on FIGS. 3, 5, and 7(a) to 7(c). FIG. 7(a) schematically depicts the steering device 10 in a plan view, in a state in which the rack 32 is positioned in the steering neutral position (the position whereby the vehicle travels directly forward). FIG. 7(b) schematically depicts the steering device 10 in a plan view, in a state in which the rack 32 is slid and displaced to the right by the steering device 10 being steered to the right. FIG. 7(c) schematically depicts the steering device 10 in a plan view, in a state in which the rack 32 is slid and displaced to the left by the steering device 10 being steered to the left.

The pressing surface 61a of the rack guide 61, having a substantially arcuate cross section and formed in the rack guide 61, is in contact with only one of any of the surfaces relative to the pinion-orthogonal reference line Lc in the back surface 16a of the rack shaft 16, as shown in FIG. 3. Therefore, the rack guide 61 presses the rack shaft 16 against the pinion 31 through the urging force F1 of the compression coil spring 62, and presses (applies precompression to) the back surface 16a of the rack shaft 16 against the bearings 50, 50, i.e., the rack support parts 50, 50, as shown in FIG. 5. As a result, the reaction force F2 is produced in the rack support parts 50, 50 as shown in FIGS. 5 and 7(a). The rack support parts 50, 50 come to support the back surface 16a of the rack shaft 16. This rack shaft support structure is equivalent to a support structure in so-called balanced conditions in which “a beam juts out from both sides of two fulcra, and a concentrated load (the reaction force from the pinion 31) acts in the longitudinal center of this beam.”

Thus, the back surface 16a of the rack shaft 16 is reliably supported by three points: the pinion 31 and the two rack support parts 50, 50, so as to be capable of sliding in the longitudinal direction without rattling. Moreover, as long as the rack shaft 16 does not flex by a large amount due to excessive bending force acting on the rack shaft 16, the rack 32 itself is not supported by (not in contact with) the rack support parts 50, 50. There is no need to provide separate support members for supporting the rack shaft 16, and the support configuration for supporting the rack shaft 16 can be simplified.

Furthermore, the pressing surface 61a of the rack guide 61, having an extremely simple configuration merely of being formed so as to be capable of contact with either the surface above or the surface below the substantially horizontal pinion-orthogonal reference line Lc (FIG. 3), can press the rack shaft 16 against the pinion 31 and can also press the back surface 16a of the rack shaft 16 against the rack support parts 50, 50. Therefore, there is no need for a separate member in order to press the back surface 16a of the rack shaft 16 against the rack support parts 50, 50.

Moreover, only one substantial half (the substantial top half) of the pressing surface 61a of the rack guide 61 is in contact with the back surface 16a of the rack shaft 16, and the other substantial half (the substantial bottom half), equivalent to a conventional rack guide, is in contact with the rack support parts 50, 50. In other words, the only friction resistance that has an effect is that of the portion equivalent to a conventional rack guide. In a conventional steering device, the friction resistance that has an effect is the combined total of the friction resistance of the rack guide and the friction resistance of the rack support parts supporting the rack shaft in the longitudinal direction. In the steering device 10 according to Embodiment 1, since the only friction resistance that has an effect is that of the portion equivalent to the rack guide 61, the friction resistance when the rack shaft 16 slides can be suppressed.

Since the rack guide 61 has only a substantial top half and has no need for a substantial bottom half, the weight can be reduced. Since the rack support parts 50, 50 have simple cylindrical configurations, they are lightweight and there is virtually no weight increase of the overall steering device 10.

Furthermore, since the rack shaft 16 can be shortened, the bending rigidity of the rack shaft 16 increases. Therefore, the angle of flexure of the rack shaft 16 in the rack support parts 50, 50 is smaller, and the state of contact between the rack shaft 16 and the support holes 51, 51 of the rack support parts 50, 50 is very favorable. The reaction force from the rack support parts 50, 50 resulting from the bending force acting on the rack shaft 16 increases in proportion to the shortening of the rack shaft 16 and the shortening of the distance between the rack support parts 50, 50, but the contact surfaces of the support holes 51, 51 can be used effectively. Therefore, there is virtually no need to increase the contact surface areas of the rack support parts 50, 50, and the rack support parts 50, 50 therefore do not increase in size.

The two rack support parts 50, 50 are capable of supporting only the back surface 16a of the region in the rack shaft 16 where the rack 32 is formed, and are positioned near each other. The rack support parts 50, 50 are positioned within the length range of the rack 32, the entire length of the rack shaft 16 can be shortened in comparison with conventional practice in which the rack support parts are positioned outside of this range of the rack 32. Therefore, the rack-and-pinion mechanism 15 can be reduced in size in the longitudinal direction of the rack 32. The housing 41 (FIG. 3) for accommodating the rack-and-pinion mechanism 15 can also be reduced in size, and the steering device 10 can therefore be reduced in size and weight.

Furthermore, the tie rods 18, 18 connected to the rack shaft 16 can be made longer in proportion to the amount by which the rack shaft 16 is shorter than in conventional practice. Therefore, it is possible to increase the degree of freedom in the design of the steering device 10 and the vehicle in which the steering device 10 is installed. For example, the degree of freedom can be increased in the design of the suspension geometry whereby the steering device 10 is formed by the tie rods 18, 18 and a suspension device (not shown).

The restrictions in placement are small particularly in cases in which the steering device 10 is installed in a compact car of small width. Moreover, if the tie rods 18, 18 are designed longer, the effect of changes in toe can be suppressed when the left and right steered wheels 21, 21 bump or rebound. As a result, the maneuverability of the vehicle can be increased.

Furthermore, the tie rods 18, 18 can be designed longer by shortening the rack shaft 16. Consequently, the angle of inclination φ (also known as the angle of incidence φ) of the tie rods 18, 18 relative to the rack shaft 16 can be designed smaller. Therefore, when the rack shaft 16 is slid and displaced in the vehicle width direction as shown in FIGS. 7(b) and 7(c), less force fb (bending force fb) acts in a direction perpendicular to the rack shaft 16. Since the bending force fb is small, the bending moment in the rack shaft 16 is small. Consequently, the bending strength of the rack shaft 16 can be increased sufficiently, and the flexing of the rack shaft 16 can be suppressed. Since the flexing of the rack shaft 16 is small, it is possible to increase the precision of the steered angle of the left and right steered wheels 21, 21 during steering. Moreover, a satisfactory meshing of the rack 32 in the pinion 31 can be maintained, and as a result, sufficient durability can be ensured in the rack-and-pinion mechanism 15.

Generally, when long tie rods 18, 18 are used, it is easy to set up a steering geometry whereby the longitudinal force (thrust, axial force) acting on the rack shaft 16 can be reduced, particularly in steering areas having a large steering angle. In other words, it is possible to set up a geometry so that the rack shaft 16, the tie rods 18, 18, and the knuckles 19, 19 have a satisfactory placement relationship (steering geometry) in steering areas having a large steering angle. An example used in a steering region having a large steering angle is so-called stationary steering, when a stopped vehicle is steered, for example.

The steering torque with which the steering wheel 11 is steered is reduced by the thrust acting on the rack shaft 16 being reduced. Since the steering torque remains low, the load on the rack-and-pinion mechanism 15 is reduced. Consequently, the rack-and-pinion mechanism 15 can be endowed with extra strength and durability, and the reliability of the rack-and-pinion mechanism 15 therefore increases.

Furthermore, when a so-called electric power steering device is used as the steering device 10, which is designed so that auxiliary torque generated by an electric motor in accordance with the steering torque is applied to the rack-and-pinion mechanism 15, the size of the electric motor can be reduced in proportion to the reduction in steering torque. Therefore, the weight of the overall steering device 10 can be reduced, and this also contributes to reducing the power consumed by the steering device 10. The load on the engine is reduced proportionately, and the vehicle employing the steering device 10 has greater fuel efficiency.

Disturbance being applied to the left and right steered wheels 21, 21 during travel, e.g., vibration in the steered wheels 21, 21 caused by unevenness in the road surface, is transmitted from the left and right steered wheels 21, 21 to the rack shaft 16 via the tie rods 18, 18, as shown in FIG. 7(a).

In contrast to Embodiment 1, when the rack 32 is positioned near the steering neutral position, precompression is applied to the left and right rack support parts 50, 50 from the back surface 16a of the rack shaft 16. Therefore, there is no gap between the back surface 16a of the rack shaft 16 and the rack support parts 50, 50. Since precompression is applied and there is no gap, noises from the back surface 16a of the rack shaft 16 touching the rack support parts 50, 50, i.e., rattling noises, caused by the aforementioned vibration can be sufficiently prevented.

For example, during right steering shown in FIG. 7(b) or during left steering shown in FIG. 7(c), the direction of reaction force received by the rack support parts 50, 50 is the direction in which precompression is applied from the back surface 16a of the rack shaft 16 to the left and right rack support parts 50, 50. Therefore, when a reversal is made between right steering and left steering, noises (rattling noises) from the back surface 16a of the rack shaft 16 touching the rack support parts 50, 50 can be sufficiently prevented.

Moreover, the rack shaft 16 is shorter than in conventional practice and is therefore lighter in weight. Even in cases in which a large disturbance exceeding the precompression is transmitted to the rack shaft 16, the rattling noises can be suppressed. Consequently, loud noises transmitted from the steering device 10 to the passenger compartment can be sufficiently prevented, and as a result, the environment inside the passenger compartment can be further improved.

### Embodiment 2

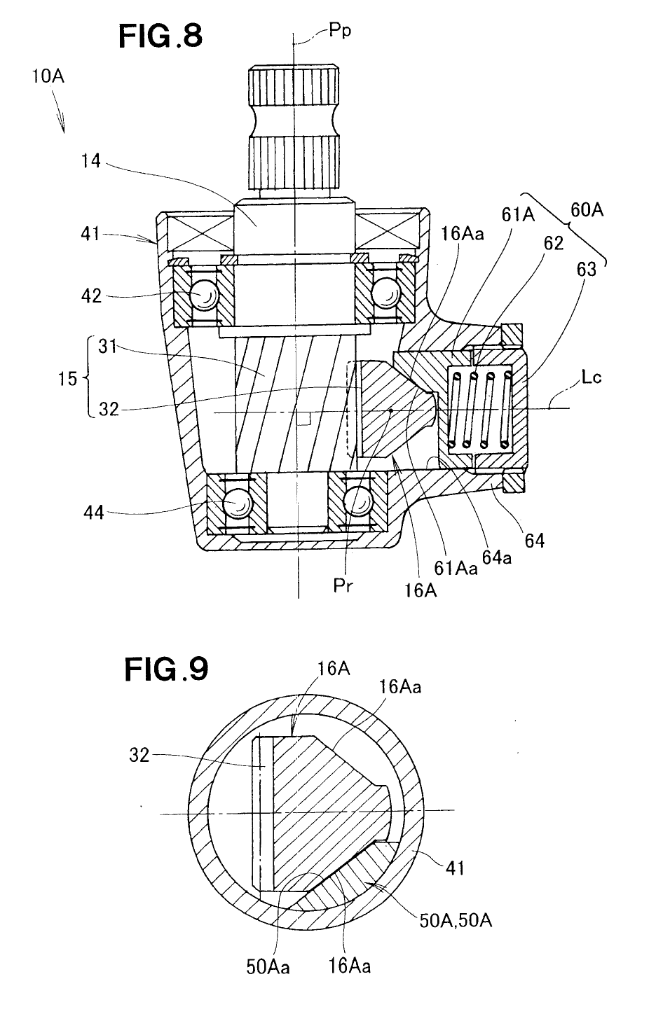

Next, a vehicle steering device according to Embodiment 2 is described based on FIGS. 8 and 9. FIG. 8 corresponds to FIG. 3. FIG. 9 corresponds to FIG. 5. The vehicle steering device 10A according to Embodiment 2 is characterized in that the rack shaft 16, the rack support parts 50, 50 and the urging part 60 (the rack guide mechanism 60) according to Embodiment 1 shown in FIGS. 3 and 5 are modified to the rack shaft 16A, the rack support parts 50A, 50A and the urging part 60A (the rack guide mechanism 60A) shown in FIGS. 8 and 9, while the configuration is otherwise the same as the configuration of Embodiment 1 shown in FIGS. 1 through 7, and descriptions thereof are therefore omitted.

When the rack shaft 16A according to Embodiment 2 is seen from the longitudinal direction, the back surface 16Aa of the surface where the rack 32 is formed is formed with a substantially tapering cross section. The taper of the back surface 16Aa of the rack shaft 16A is formed to be symmetrical above and below the pinion-orthogonal reference line Lc. Therefore, the cross section of the entire rack shaft 16A is also symmetrical above and below the pinion-orthogonal reference line Lc.

The rack guide mechanism 60A (the urging part 60A) is composed of a rack guide 61A which touches the rack shaft 16A from the side opposite the rack 32, a compression coil spring 62, and an adjusting bolt 63. A pressing surface 61Aa of the rack guide 61A is formed as an inclined surface along the back surface 16Aa of the rack shaft 16A. This pressing surface 61Aa of the rack guide 61A is formed so as to be capable of contact only with any one surface of the back surface 16Aa of the rack shaft 16A, relative to the pinion-orthogonal reference line Lc. For example, the pressing surface 61Aa of the rack guide 61A is capable of contact only with either the surface above or the surface below the horizontal pinion-orthogonal reference line Lc. In FIG. 8, the pressing surface 61Aa of the rack guide 61A is in contact with only the back surface 16Aa above the pinion-orthogonal reference line Lc.

Two rack support parts 50A, 50A are members which support the back surface 16Aa of the rack shaft 16A, and are configured from protruding members which protrude into the housing 41, as shown in FIG. 9. Support surfaces 50Aa, 50Aa of the rack support parts 50A, 50A are inclined surfaces corresponding to the substantially tapered back surface 16Aa. Since the pressing surface 61Aa of the rack guide 61A (FIG. 8) is in contact only with the surface above the pinion-orthogonal reference line Lc, the support surfaces 50Aa, 50Aa are in contact only with the surface on the opposite side, i.e., the surface below the pinion-orthogonal reference line Lc. The rack support parts 50A, 50A are preferably configured from materials whose friction resistance is low when the pinion shaft 14 (FIG. 8) slides.

According to Embodiment 2, the same actions and effects as those of Embodiment 1 are exhibited. Using the rack shaft 16A having such a cross-sectional shape improves the bending rigidity of the rack shaft 16A and reduces the angle of flexure of the rack shaft 16A. As a result, the state of contact is even more favorable in the contact portions 16Aa, 50Aa (the back surface 16Aa and the support surfaces 50Aa) between the rack shaft 16A and the rack support parts 50A, 50A. As a result, the rack support parts 50A, 50A can be endowed with extra bearing capacity (amount of allowable load). Consequently, the rack support parts 50A, 50A can be reduced in size if the bearing capacity is the same as in Embodiment 1. Furthermore, since the amount of flexure in the rack shaft 16A is reduced, the steered wheels 21, 21 (FIG. 1) have improved precision in the steering angle caused by the flexing of the rack 32, and this also contributes to improved maneuverability.

### Embodiment 3

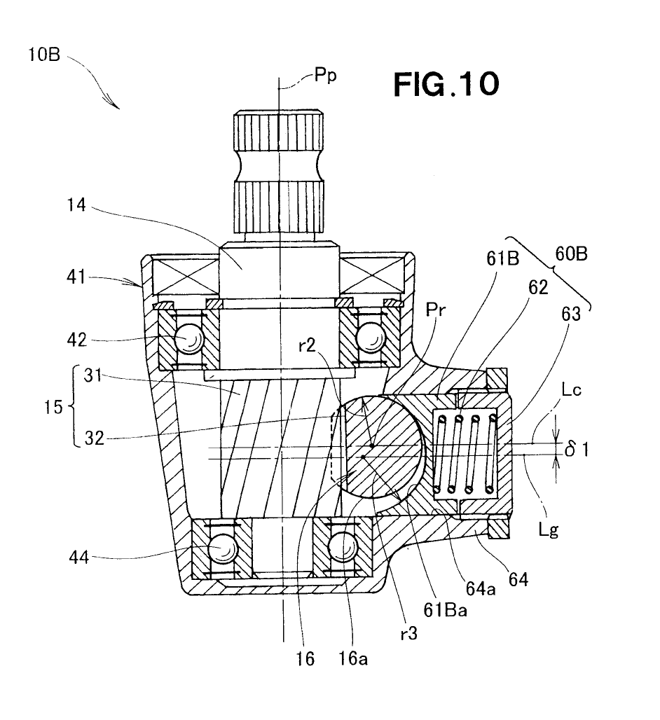

Next, a vehicle steering device according to Embodiment 3 is described based on FIG. 10. FIG. 10 corresponds to FIG. 3. The vehicle steering device 10B of Embodiment 3 differs in that the urging part 60 (the rack guide mechanism 60) shown in FIG. 3 has been modified to the urging part 60B (the rack guide mechanism 60B) shown in FIG. 10. The configuration is otherwise the same as that of Embodiment 1 shown in FIGS. 1 through 7, and descriptions thereof are therefore omitted.

The rack guide mechanism 60B (the urging part 60B) according to Embodiment 3 is composed of a rack guide 61B which touches the rack shaft 16 from the side opposite the rack 32, a compression coil spring 62, and an adjusting bolt 63. A pressing surface 61Ba of the rack guide 61B is formed in a substantially arcuate cross section along the back surface 16a of the rack shaft 16. This pressing surface 61Ba of the rack guide 61B is formed so as to be capable of contact only with any one surface of the back surface 16a of the rack shaft 16, relative to the pinion-orthogonal reference line Lc. For example, the pressing surface 61Ba of the rack guide 61B is capable of contact only with either the surface above or the surface below the horizontal pinion-orthogonal reference line Lc.

In the rack guide mechanism 60B, the center line Lg of the rack guide 61B and the center line Lg of the compression coil spring 62 are offset by an offset amount 61 either above or below the pinion-orthogonal reference line Lc. In other words, the center of the pressing surface 61Ba of the rack guide 61B is offset in the face width direction of the rack 32 from the center of the rack shaft 16. The radius r3 of the arc of the pressing surface 61Ba of the rack guide 61B is set to be greater than the radius r2 of the arc of the back surface 16a of the rack shaft 16 (r3>r2).

Specifically, the center of the radius r2 of the back surface 16a of the rack shaft 16 is positioned on the pinion-orthogonal reference line Lc. The center of the radius r3 of the arc of the pressing surface 61Ba of the rack guide 61B is offset either above or below the pinion-orthogonal reference line Lc, i.e., in the face width direction of the rack 32. As a result, the pressing surface 61Ba of the rack guide 61B is in contact only with either the surface above or the surface below the horizontal pinion-orthogonal reference line Lc. In FIG. 10, the pressing surface 61Ba of the rack guide 61B is in contact with only one side of the back surface 16a above the pinion-orthogonal reference line Lc.

According to Embodiment 3, the same actions and effects as those of Embodiment 1 described above are exhibited. Furthermore, according to Embodiment 3, the pressing surface 61Ba of the rack guide 61B has a very simple configuration merely in which the radius r3 of the arc of the pressing surface 61Ba of the rack guide 61B is set to be greater than the radius r2 of the arc of the back surface 16a of the rack shaft 16, and the center of the pressing surface 61Ba of the rack guide 61B is offset in the face width direction of the rack 32 from the center of the rack shaft 16; whereby the rack shaft 16 can be pressed against the pinion 31 and the back surface 16a of the rack shaft 16 can be pressed against the rack support parts 50, 50. Moreover, there is no need to provide separate support members for supporting the rack shaft 16.

In the configuration of Embodiment 1 shown in FIG. 3, even if the rack guide 61 is assembled upside-down relative to the rack guide housing 64, the friction resistance of the steering device 10 (FIG. 1) does not change, and the upside-down assembly cannot be detected.

Furthermore, in the configuration of Embodiment 2 shown in FIGS. 8 and 9, when the rack guide 61A is assembled upside-down relative to the rack guide housing 64, the rack shaft 16A is pushed in a direction not toward the rack support parts 50A, 50A.

In the configuration of Embodiment 3, even if the rack guide 61B is assembled upside-down relative to the rack guide housing 64, the direction in which force acts is the same, there is no concern over incorrect assembly, and productivity is increased.

### Embodiment 4

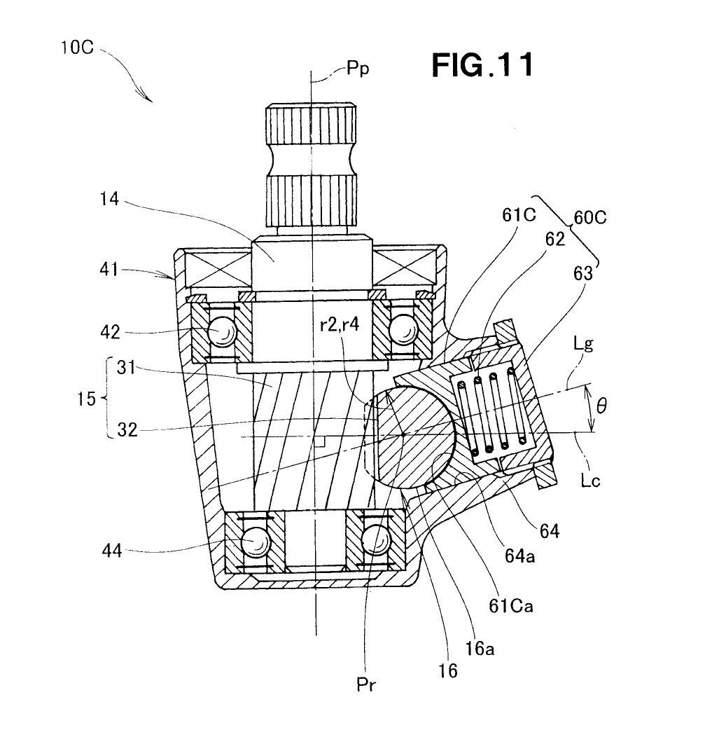

Next, the vehicle steering device according to Embodiment 4 is described based on FIG. 11. FIG. 11 corresponds to FIG. 3. In the vehicle steering device 10C of Embodiment 4, the urging part 60 (the rack guide mechanism 60) shown in FIG. 3 is modified to the urging part 60C (the rack guide mechanism 60C) shown in FIG. 11. The configuration is otherwise the same as the configuration shown in FIGS. 1 through 7, and descriptions are therefore omitted.

The rack guide mechanism 60C (the urging part 60C) according to Embodiment 4 is composed of a rack guide 61C which touches the rack shaft 16 from the side opposite the rack 32, a compression coil spring 62, and an adjusting bolt 63. A pressing surface 61Ca of the rack guide 61C is formed in a substantially arcuate cross section along the back surface 16a of the rack shaft 16. The center line Lg of the rack guide 61C and the center line Lg of the compression coil spring 62 pass through the cross-sectional center (the center line Pr) of the rack shaft 16, and these center lines are inclined by an angle of inclination θ in the axial direction of the pinion 31 relative to the pinion-orthogonal reference line Lc. The shape of the pressing surface 61Ca of the rack guide 61C is not a gothic arch, but is a simple arc. The radius r4 of the arc of the pressing surface 61Ca of the rack guide 61C is set to be equal to or slightly greater than (substantially equal to) the radius r2 of the arc of the back surface 16a of the rack shaft 16 (r4>r2).

According to Embodiment 4, the same actions and effects as those of Embodiment 1 are exhibited. Similar to Embodiment 3, even if the rack guide 61C is assembled upside-down relative to the rack guide housing 64, the direction in which force acts is the same, there is no concern over incorrect assembly, and productivity is increased. Furthermore, according to Embodiment 4, the center line Lg of the rack guide 61C passes through the cross-sectional center Pr of the rack shaft 16, and the center line Lg is inclined by an angle of inclination θ in the axial direction of the pinion 31 relative to the pinion-orthogonal reference line Lc. Due to such a rack guide 61C having a very simple configuration, the rack shaft 16 can be pressed against the pinion 31 and the back surface 16a of the rack shaft 16 can be pressed against the rack support parts 50, 50. Moreover, there is no need to provide separate support members for supporting the rack shaft 16.

### Embodiment 5

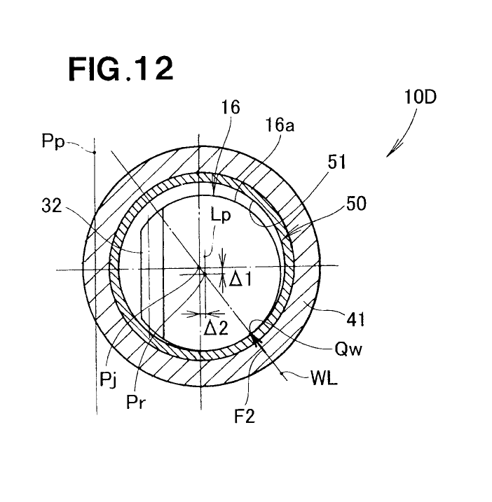

Next, the vehicle steering device according to Embodiment 5 is described based on FIG. 12. FIG. 12 corresponds to FIG. 5. In the vehicle steering device 10D according to Embodiment 5, the offset configuration of the rack shaft 16 relative to the bearings 50, 50 shown in FIG. 5 is modified, and the basic configuration is the same as that of Embodiment 4 shown in FIG. 11. Thus, the configuration of Embodiment 5 is otherwise the same as the configuration shown in FIGS. 1 through 7 and FIG. 11, and descriptions are therefore omitted.

The cross-sectional center Pr (the center line Pr) of the rack shaft 16 of Embodiment 5 is offset relative to the cross-sectional center Pj (the center line Pj) of the rack support parts 50, 50, by an offset amount Δ2 in a direction away from the pinion 31 (FIG. 6), and also by an offset amount Δ1 in the face width direction of the rack 32. As a result, the rack shaft 16 has a contact point Qw on the line of action WL connecting the cross-sectional center Pj of the rack support parts 50, 50 and the cross-sectional center Pr of the rack shaft 16, and reaction force F2 occurs in the direction of this line of force WL, as shown in FIG. 12. The rack support parts 50, 50 come to support the back surface 16a of the rack shaft 16. This rack shaft support structure is equivalent to a support structure in so-called balanced conditions in which “a beam juts out from both sides of two fulcra, and a concentrated load (the reaction force from the pinion 31) acts in the longitudinal center of this beam.” The offsetting in the offset amount Δ2 is not necessary. In cases of no such offsetting, the reaction force F2 occurs from a rack bottom point Qu.

Thus, the back surface 16a of the rack shaft 16 is reliably supported so as to be capable of sliding in the longitudinal direction by three points: the pinion 31 and the two rack support parts 50, 50. Moreover, it is possible to more reliably prevent the rack 32 itself from being supported by (from being in contact with) the two bearings 50, 50.

### Embodiment 6

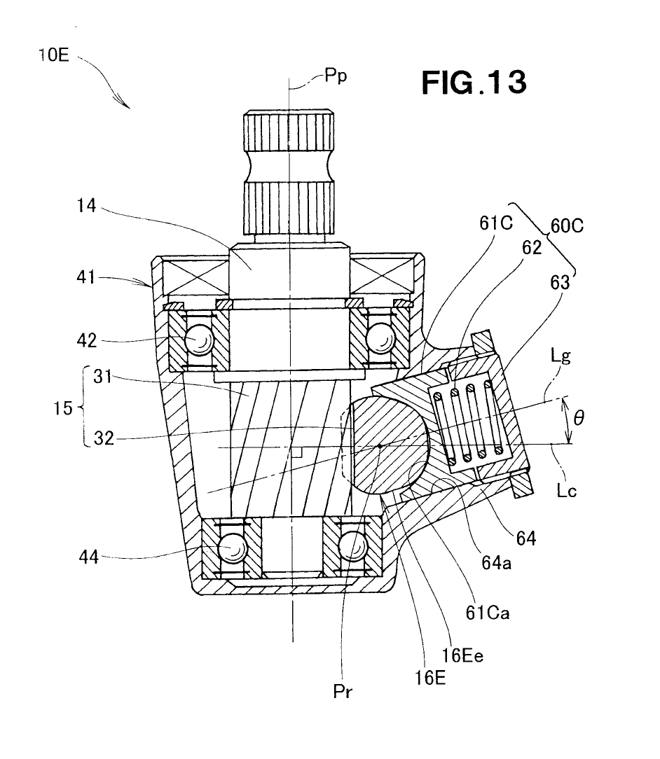

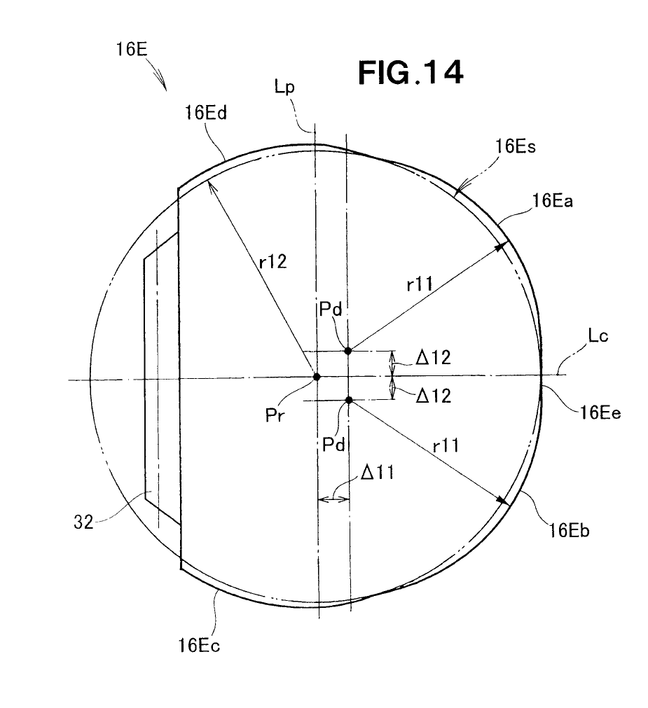

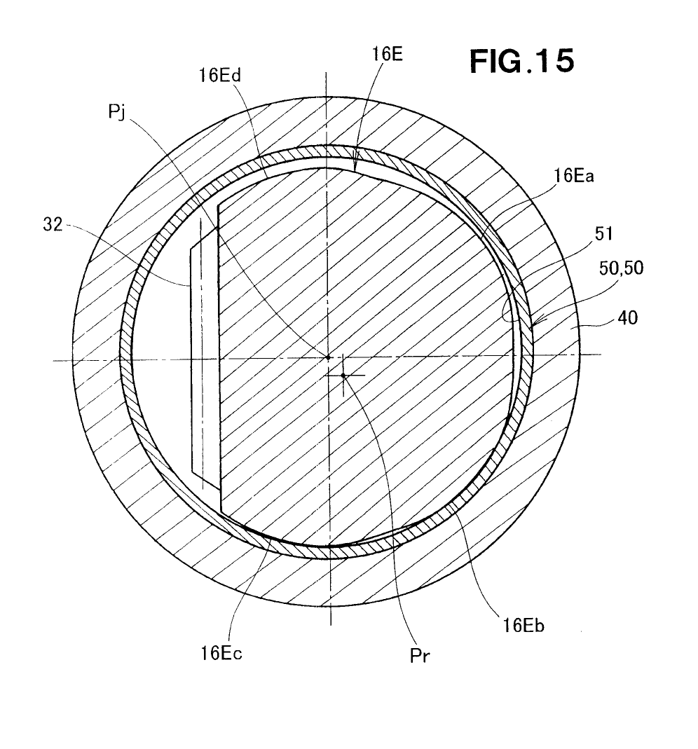

The vehicle steering device according to Embodiment 6 is described based on FIGS. 13 to 15. FIG. 13 corresponds to FIG. 11. FIG. 14 shows the cross-sectional shape of the rack shaft 16E of Embodiment 6 as though it were sliced. FIG. 15 corresponds to FIG. 12 and shows the configuration of the rack shaft 16E being supported by the two bearings 50, 50.

In the vehicle steering device 10E according to Embodiment 6, the rack shaft 16 shown in FIGS. 11 and 12 is modified to the rack shaft 16E shown in FIGS. 13 to 15. The urging part 60C (the rack guide mechanism 60C) has substantially the same configuration as that of Embodiment 4 shown in FIG. 11, but the configuration of either Embodiment 1 or Embodiment 3 may also be used. The configuration of the vehicle steering device 10E is otherwise the same as the configuration shown in FIGS. 1 through 7 and FIG. 11, and descriptions are therefore omitted.

The rack shaft 16E is a forged product, and two rack-opposite convex parts 16Ea, 16Eb and two rack-adjacent convex parts 16Ec, 16Ed capable of being supported by the two bearings 50, 50 (FIG. 15) are formed in the same periphery of the external peripheral surface (the perfectly circular circumferential surface 16Es shown by the imaginary lines in FIG. 14) excluding the portion where the rack 32 is formed, as shown in FIG. 14. These convex parts 16Ea, 16Eb, 16Ec, 16Ed, which are protruding parts arcuate in cross section and protruding radially outward from the circumferential surface 16Es, extend in the longitudinal direction throughout the entire length of the rack shaft 16E.

The two rack-opposite convex parts 16Ea, 16Eb are positioned on the side of the pinion-parallel reference line Lp opposite the rack 32, and are also positioned to both sides of the pinion-orthogonal reference line Lc. In other words, the rack-opposite convex parts 16Ea, 16Eb are positioned in the back surface 16Ee of the region in the rack shaft 16E where the rack 32 is formed. The two rack-adjacent convex parts 16Ec, 16Ed are positioned between the pinion-parallel reference line Lp and the rack 32, and are also positioned to both sides of the pinion-orthogonal reference line Lc.

For example, the radii r11 of the cross-sectionally arcuate rack-opposite convex parts 16Ea, 16Eb are set to be less than the radius r12 of the perfectly circular circumferential surface 16Es. The centers Pd of the radii r11 of the rack-opposite convex parts 16Ea, 16Eb are each offset from the pinion-parallel reference line Lp by an offset amount Δ11 toward the side opposite the rack 32, and are also offset by an offset amount Δ12 away from the pinion-orthogonal reference line Lc.

In FIG. 14, the rack-opposite convex part 16Ea in the upper right of the drawing is referred to as the “first rack-opposite convex part 16Ea.” The rack-opposite convex part 16Eb in the lower right of the drawing is referred to as the “second rack-opposite convex part 16Eb.” The rack-adjacent convex part 16Ec in the lower left of the drawing is referred to as the “first rack-adjacent convex part 16Ec.” The rack-adjacent convex part 16Ed in the upper left of the drawing is referred to as the “second rack-adjacent convex part 16Ed.”

The bearings 50, 50 support the second rack-opposite convex part 16Eb so as to be capable of sliding in the longitudinal direction of the rack shaft 16E, as shown in FIG. 15.

According to Embodiment 6, the same actions and effects as those of Embodiment 1 are exhibited. Furthermore, in Embodiment 6, the first rack-opposite convex part 16Ea and the second rack-opposite convex part 16Eb, which can be supported by the cylindrical bearings 50, 50, are formed on the same periphery of the external peripheral surface of the rack shaft 16E excluding the portion containing the rack 32. These two rack-opposite convex parts 16Ea, 16Eb are positioned on the side of the pinion-parallel reference line Lp opposite the rack 32, and are also positioned to both sides of the pinion-orthogonal reference line Lc. Furthermore, the center line Lg of the rack guide 61C passes through the cross-sectional center Pr (the center line Pr) of the rack shaft 16, and this center line Lg is inclined relative to the pinion-orthogonal reference line Lc at an angle of inclination θ in the axial direction of the pinion 31.

Therefore, rather than supporting the entire back surface of the rack shaft 16E, the bearings 50, 50 can support at least either one of the two rack-opposite convex parts 16Ea, 16Eb. In Embodiment 6 shown in FIGS. 13 and 14, for example, the rack guide 61C is inclined upward from the pinion-orthogonal reference line Lc. Therefore, the second rack-opposite convex part 16Eb, which is positioned below the pinion-orthogonal reference line Lc, is usually supported by the bearings 50, 50.

Generally, when the vehicle is steered while traveling, the steering force remains comparatively small because the frictional force between the road surface and the steered wheels 21, 21 (FIG. 1) is small. At this time, of the reaction force acting from the steered wheels 21, 21 via the knuckles 19, 19 and then from the tie rods 18, 18, the bending force fb (FIG. 7) acting on the rack shaft 16E is small, and a small pressing force therefore presses the back surface 16Ee of the rack shaft 16E against the bearings 50, 50. In this case, the rack-opposite convex parts 16Ea, 16Eb positioned on the side of the pinion-orthogonal reference line Lc opposite the rack guide 61C are supported on the bearings 50, 50. The support point in the rack shaft 16E that is supported by the bearings 50, 50 is reliably established.

Of the reaction force inputted from the steered wheels 21, 21 via the knuckles 19, 19 and then from the tie rods 18, 18, when the bending force fb (FIG. 7) acting on the rack shaft 16E is large, the pressing force whereby the back surface 16Ee of the rack shaft 16E is pressed against the bearings 50, 50 is also large. In this case, both of the two rack-opposite convex parts 16Ea, 16Eb positioned on both sides of the pinion-orthogonal reference line Lc are supported on the bearings 50, 50, and the reaction force acting on the bearings 50, 50 due to the lateral load fb is divided between two locations. Therefore, the durability of the rack shaft 16E and the bearings 50, 50 increases because excessive steering force does not act on a single point of the bearings 50, 50.

Furthermore, in Embodiment 6, the first rack-adjacent convex part 16Ec and the second rack-adjacent convex part 16Ed, which can be supported by the two bearings 50, 50, are formed on the same periphery of the external peripheral surface of the rack shaft 16E. These two rack-adjacent convex parts 16Ec, 16Ed are positioned between the pinion-parallel reference line Lp and the rack 32, and are also positioned on both sides of the pinion-orthogonal reference line Lc.

When the vehicle is steered while stopped, i.e., during so-called stationary steering, the frictional force between the road surface and the steered wheels 21, 21 (FIG. 1) is large. In other words, a greater steering force is needed because the road surface reaction force is large. A greater steering force is transmitted from the pinion 31 to the rack 32. The rack shaft support configuration is a configuration in which the rack shaft 16E juts out from both sides of the two bearings 50, 50, and a concentrated load (the pressing force from the pinion 31) acts in the longitudinal center of the rack shaft 16E. Due to the greater pressing force acting on the longitudinal center of the rack shaft 16E from the pinion 31, both sides of the rack shaft 16E act as though to flex toward the rack 32. Therefore, the rack 32 formed in the rack shaft 16E acts as though to contact the bearings 50, 50. However, since at least one of the two rack-adjacent convex parts 16Ec, 16Ed comes in contact first with the bearings 50, 50 in this case, the rack 32 does not come in contact with the bearings 50, 50. Consequently, the rack shaft 16E can slide more smoothly.

Because of such a configuration, there is no need for the center Pj of the housing 40 or the bearings 50, 50 to be offset. The arc of the pressing surface 61Ca of the rack guide 61C needs only a single center. Therefore, the productivity of the vehicle steering device 10E is increased.

### Embodiment 7

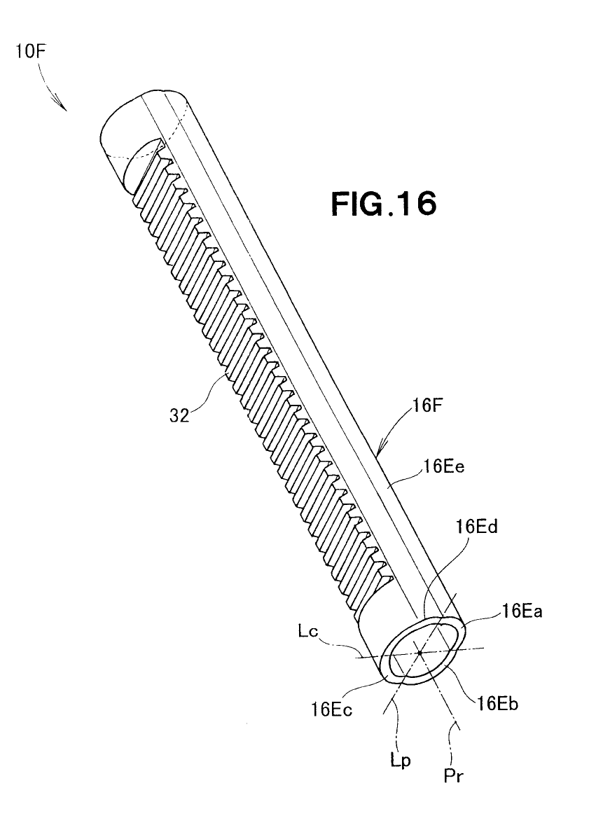

The vehicle steering device according to Embodiment 7 is described based on FIGS. 16 to 18. In the vehicle steering device 10F according to Embodiment 7, the rack shaft 16E shown in FIG. 14 is modified to the rack shaft 16F shown in FIG. 16, while the configuration is otherwise the same as the configuration shown in FIGS. 1 through 7 and FIGS. 13 through 15, and descriptions are therefore omitted.

The rack shaft 16F of Embodiment 7 is configured by plastic machining a hollow member, as shown in FIG. 16. This hollow member is made of a steel pipe or another metal pipe. The two rack-opposite convex parts 16Ea, 16Eb and the two rack-adjacent convex parts 16Ec, 16Ed are portions formed by extrusion molding the hollow member 16F (the rack shaft 16F) radially outward from the inside.

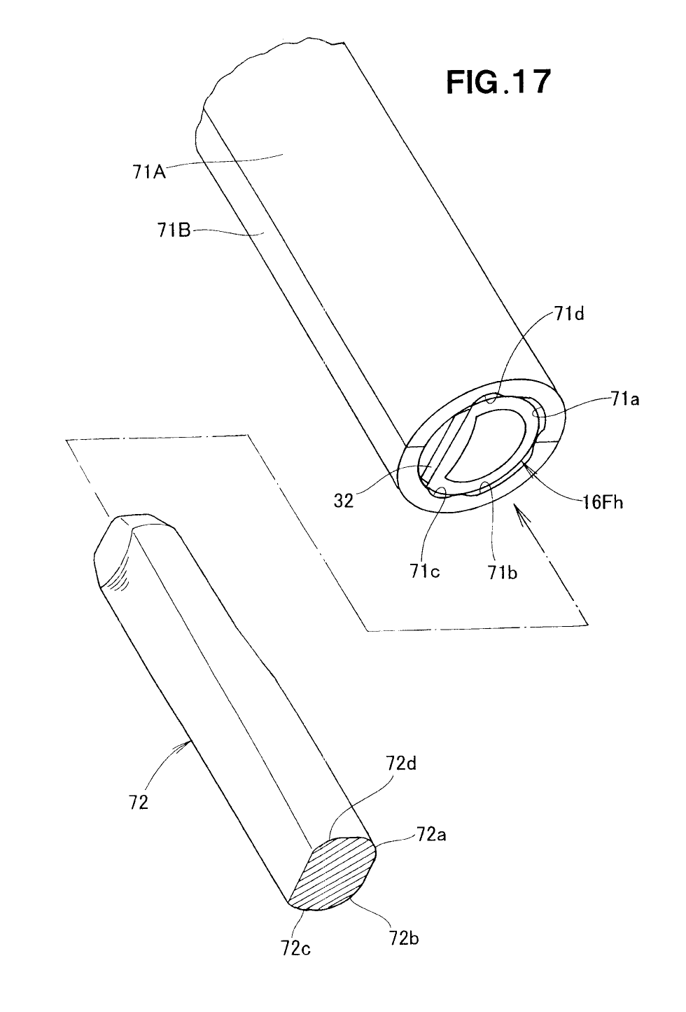

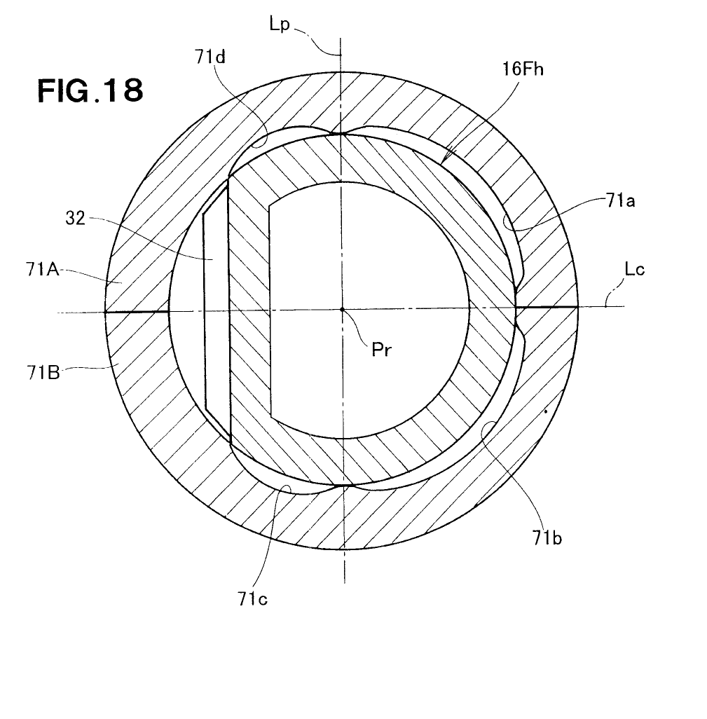

The following is a description of an example of a method for manufacturing the rack shaft 16F. First, a pipe member of a predetermined length made of a steel pipe is prepared (first step). Next, the pipe member is crushed into a flat shape by a press at some longitudinal point, forming a flat part (second step). Next, this flat part is subjected to plastic machining, e.g., component rolling, thereby forming the rack 32 (third step). The rack shaft 16Fh, a semi-finished product in which the rack 32 is thus formed in a pipe material (semi-complete rack shaft 16Fh) by the procedure from the first step to the third step, is shown in FIGS. 17 and 18.

The procedure from the first step to the third step, i.e., the method for manufacturing the semi-complete rack shaft 16Fh from a pipe material, is conventionally known as is shown in Japanese Examined Patent Application No. 3-5892 or Japanese Laid-open Patent Publication No. 2001-163228, for example; moreover, there are various examples and any desired method can be used, and a detailed description is therefore omitted.

Next, a pair of secondary forming split dies 71A, 71B and a punch 72 for additionally machining the semi-complete rack shaft 16Fh are prepared as shown in FIGS. 17 and 18. The pair of split dies 71A, 71B combined together form a cylinder as a whole, the internal peripheral surface of which has concave parts 71a, 71b, 71c, 71d for forming the convex parts 16Ea, 16Eb, 16Ec, 16Ed shown in FIG. 16. In the external peripheral surface of the punch 72 are formed convex parts 72a, 72b, 72c, 72d for forming the convex parts 16Ea, 16Eb, 16Ec, 16Ed.

After the semi-complete rack shaft 16Fh has been set in and clamped into the pair of split dies 71A, 71B, the punch 72 is forcefully pressure-fitted into the semi-complete rack shaft 16Fh, and the convex parts 16Ea, 16Eb, 16Ec, 16Ed are thereby formed in the external peripheral surface of the semi-complete rack shaft 16Fh. As a result, the rack shaft 16F having the convex parts 16Ea, 16Eb, 16Ec, 16Ed is completed as shown in FIG. 16.

An example of divided machining was given above for the sake of the description, but in practice, to improve the precision of the rack teeth profiles and the convex parts 16Ea, 16Eb, 16Ec, 16Ed after formation, the third step and the step of forming the convex parts 16Ea, 16Eb, 16Ec, 16Ed can be performed simultaneously by providing a convex part for forming the rack teeth profiles to the punch 72.

According to Embodiment 7, the same actions and effects as those of Embodiment 6 are exhibited. Furthermore, in Embodiment 7, the two rack-opposite convex parts 16Ea, 16Eb and the two rack-adjacent convex parts 16Ec, 16Ed are formed by extrusion molding radially outward from the inside of the rack shaft 16F made of a hollow member. Therefore, the surfaces of the rack-opposite convex parts 16Ea, 16Eb and the rack-adjacent convex parts 16Ec, 16Ed are even smoother (the surface roughness is satisfactory). Consequently, it is possible to suppress the friction resistance of the convex parts 16Ea to 16Ed against the bearings 50, 50 when the rack shaft 16F slides.

Moreover, the rack-opposite convex parts 16Ea, 16Eb and the rack-adjacent convex parts 16Ec, 16Ed are increased in hardness through work hardening by cold forging. It is thereby possible to effectively increase the hardness of only the rack-opposite convex parts 16Ea, 16Eb and the rack-adjacent convex parts 16Ec, 16Ed which contact the bearings 50, 50, i.e., of only the portions that slide while in contact. As a result, abrasion caused by sliding can be reduced in the rack-opposite convex parts 16Ea, 16Eb and the rack-adjacent convex parts 16Ec, 16Ed.

Furthermore, since the weight of the rack shaft 16F is reduced, rattling noises that occur from disturbance from the steered wheels 21, 21 (FIG. 1) are also reduced. By reducing the weight of the rack shaft 16F, the precompression load of the compression coil spring 62 of the rack guide mechanism 60C (FIG. 13) can be reduced. The friction resistance of the steering device 10F is thereby reduced, and satisfactory steering characteristics are achieved.

### Embodiment 8

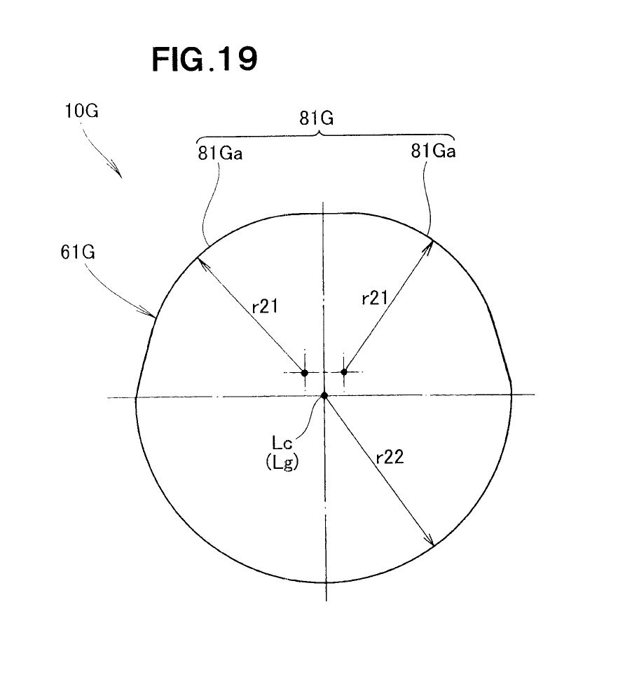

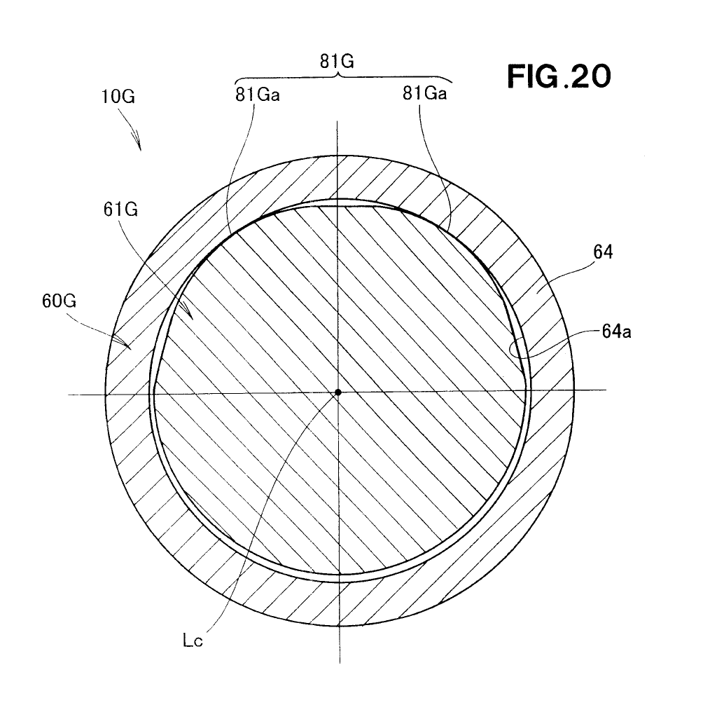

The vehicle steering device according to Embodiment 8 is described based on FIGS. 19 and 20. In the vehicle steering device 10G of Embodiment 8, the rack guide 61 of the urging part 60 (the rack guide mechanism 60) shown in FIGS. 3 and 6 is modified to the rack guide 61G of the urging part 60G (the rack guide mechanism 60G) shown in FIGS. 19 and 20. The configuration is otherwise the same as the configuration shown in FIGS. 1 through 7, and descriptions are therefore omitted.

Generally, static frictional force occurs between the external surface of the rack guide 61G and the internal surface of the supporting hole 64a (the wall surface where the hole is formed). Due to the sliding of the rack shaft 16 (FIG. 3), a dynamic frictional force greater than the static frictional force occurs between the rack shaft 16 and the rack guide 61G. Therefore, due to the difference between the extent of the static frictional force and the extent of the dynamic frictional force, a force which swings (oscillates) about the pinion-orthogonal reference line Lc, i.e., a so-called swinging force can be made to act on the rack guide 61G. As a result, the rack guide 61G acts as though to intermittently vibrate (self-induced vibration). Such a phenomenon is not advantageous in terms of maintaining smooth sliding action in the rack shaft 16 or maintaining satisfactory meshing of the rack 32 with the pinion 31.

In the contrast to this, in Embodiment 8, the rack guide 61G comprises a swing regulator 81G for regulating the swinging of the rack guide 61G relative to the pinion-orthogonal reference line Lc. Therefore, when a swinging force acts on the rack guide 61G fitted into the supporting hole 64a as though to cause the rack guide 61G to swing about the pinion-orthogonal reference line Lc, the swinging of the rack guide 61G can be regulated by the swing regulator 81G. Consequently, smooth sliding action can be maintained in the rack shaft 16, a satisfactory meshing of the rack 32 with the pinion 31 can be sufficiently maintained, and the durability of the rack-and-pinion mechanism 15 can be increased. Furthermore, the durability of the rack guide 61G itself can also be increased.

Furthermore, the swing regulator 81G is configured from at least two convex parts 81Ga, 81Ga formed in the circumferential direction of the external peripheral surface of the rack guide 61G. The convex parts 81Ga, 81Ga are formed as arcuate shapes each having a radius r21 when the rack guide 61G is viewed along the pinion-orthogonal reference line Lc. The radii r21 of the convex parts 81Ga, 81Ga are less than the radius r22 of the rack guide 61G. Thus, the swing regulator 81G can be given a very simple configuration merely by providing at least two convex parts 81Ga, 81Ga to the external peripheral surface of the rack guide 61G. Moreover, due to the rack guide 61G being configured from a sintered metal, a resin, or the like, it is very easy to form the convex parts 81Ga, 81Ga in the rack guide 61G.

According to Embodiment 8, the same actions and effects are exhibited as those of Embodiment 1.

### Embodiment 9

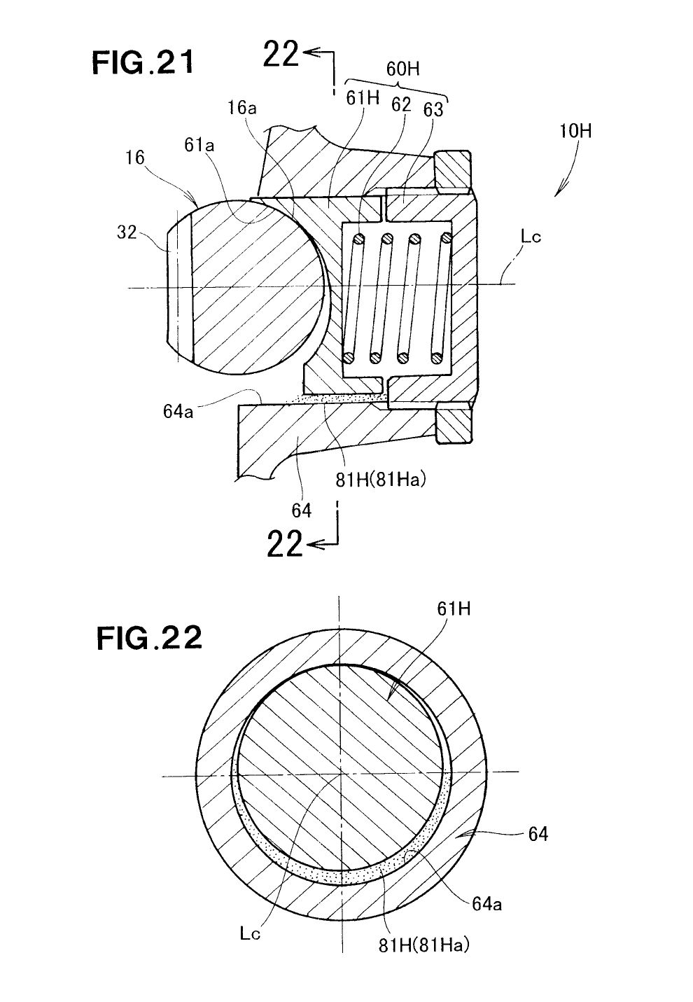

The vehicle steering device according to Embodiment 9 is described based on FIGS. 21 and 22. In the vehicle steering device 10H of Embodiment 9, the rack guide 61G and the swing regulator 81G of the urging part 60G (the rack guide mechanism 60G) shown in FIGS. 19 and 20 are modified to the rack guide 61H and the swing regulator 81H of the urging part 60H (the rack guide mechanism 60H) shown in FIGS. 21 and 22. The configuration is otherwise the same as the configuration shown in FIGS. 1 through 7, 19, and 20, and descriptions are therefore omitted.

Specifically, the rack guide 61H of Embodiment 9 comprises a swing regulator 81H for regulating the swinging of the rack guide 61H relative to the pinion-orthogonal reference line Lc. This swing regulator 81H is configured from a liquid packing or another viscoelastic packed bed 81Ha, which is filled into the gap between the external peripheral surface of the rack guide 61H and the internal peripheral surface of the supporting hole 64a of the rack guide housing 64. The swing regulator 81H can be given a very simple configuration merely by providing the packed bed 81Ha in the gap.

### Embodiment 10

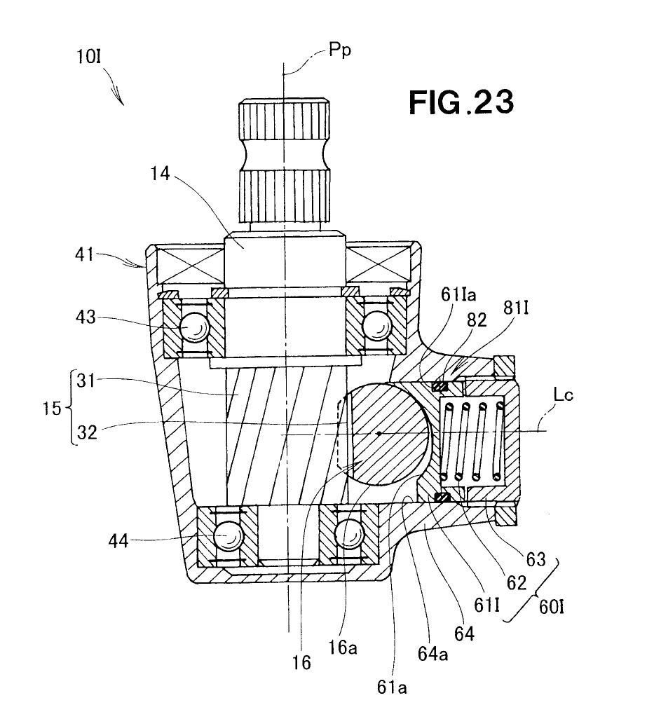

The vehicle steering device according to Embodiment 10 is described based on FIG. 23. In the vehicle steering device 10I of Embodiment 10, the rack guide 61H and the swing regulator 81H of the urging part 60H (the rack guide mechanism 60H) shown in FIGS. 21 and 22 are modified to the rack guide 61I and the swing regulator 81I of the urging part 60I (the rack guide mechanism 60I) shown in FIG. 23. The configuration is otherwise the same as the configuration of Embodiment 9 shown in FIGS. 21 and 22, and descriptions are therefore omitted.

The rack guide 61I of Embodiment 10 comprises the swing regulator 81I for regulating the swinging of the rack guide 61I about the pinion-orthogonal reference line Lc. The rack guide 61I, which has an annular groove 61Ia for mounting an O ring 82 formed in the external peripheral surface, is accommodated in the rack guide housing 64. The annular groove 61Ia can be provided by performing cut machining on the rack guide 61I, for example. Formed in the rack guide housing 64 is a supporting hole 64a for slidably supporting the rack guide 61I in which the O ring 82 is mounted.

The swing regulator 81I is configured from the O ring 82 mounted in the annular groove 61Ia. The entire external peripheral surface of this O ring 82 is in contact with the internal surface of the supporting hole 64a. Thus, the swing regulator 81I can be configured from a very simple configuration merely in which the O ring 82 is mounted in the annular groove 61Ia formed in the external peripheral surface of the rack guide 61I.

Moreover, providing the swing regulator 81I in the narrow gap between the external peripheral surface of the rack guide 61I and the internal peripheral surface of the supporting hole 64a can be achieved by simple steps including merely the step of forming the annular groove 61Ia in the external peripheral surface of the rack guide 61I, the step of mounting the O ring 82 in the annular groove 61Ia, and the step of fitting the rack guide 61I with the mounted O ring 82 into the supporting hole 64a.

### Embodiment 11

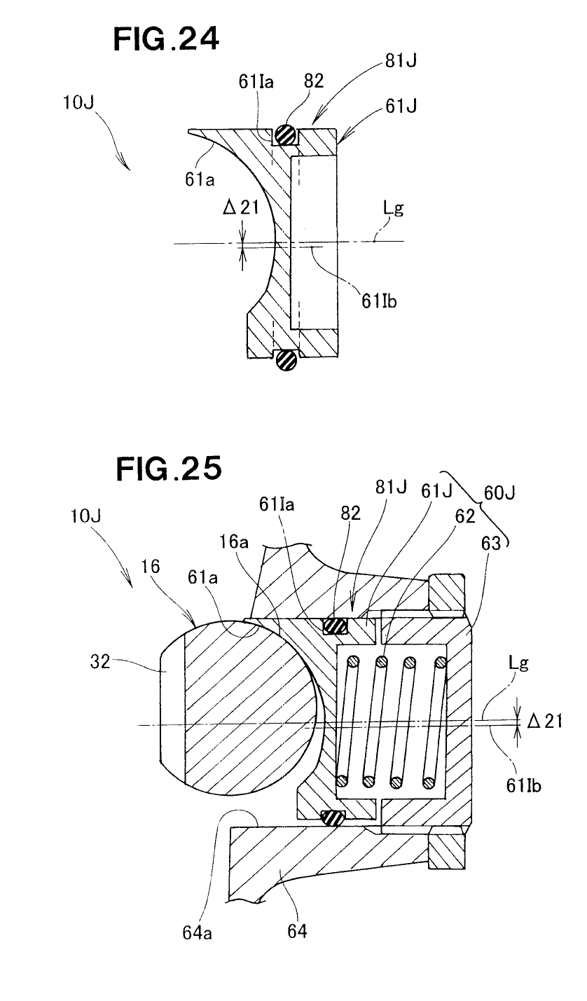

The vehicle steering device according to Embodiment 11 is described based on FIGS. 24 and 25. In the vehicle steering device 10J of Embodiment 11, the rack guide 61I and the swing regulator 81I of the urging part 60I (the rack guide mechanism 60I) of Embodiment 10 shown in FIG. 23 are modified to the rack guide 61J and the swing regulator 81J of the urging part 60J (the rack guide mechanism 60J) shown in FIGS. 24 and 25. The configuration is otherwise the same as the configuration of Embodiment 10 shown in FIG. 23, and descriptions are therefore omitted.

The swing regulator 81J of Embodiment 11 is configured from an O ring 82 mounted in an annular groove 61Ia, similar to the swing regulator 81I of Embodiment 10 shown in FIG. 23. Furthermore, the center 61Ib of the annular groove 61Ia of the rack guide 61J of Embodiment 11 is offset by an offset amount Δ21 from the center line Lg of the rack guide 61J. Therefore, the depth of the annular groove 61Ia differs depending on its position in the circumferential direction of the rack guide 61J. Consequently, the protruding amount by which the O ring 82 fitted in the annular groove 61Ia protrudes from the external peripheral surface of the rack guide 61J differs depending on the position in the circumferential direction of the rack guide 61J. The direction of the offset is on the side of the center line Lg of the rack guide 61J that is opposite of the region where the pressing surface 61a of the rack guide 61J contacts the back surface 16a of the rack shaft 16.

This causes the contact pressure of the O ring 82 against the internal peripheral surface of the supporting hole 64a to differ depending on the location in the external peripheral surface of the O ring 82, when the rack guide 61J is fitted in the supporting hole 64a. In other words, the contact pressure differs in the circumferential direction of the O ring 82. Since the contact pressure differs depending on the location in the external peripheral surface of the O ring 82, the swinging of the rack guide 61J about the pinion-orthogonal reference line Lc can be further regulated. Therefore, the holding performance, whereby the rack guide 61J is held in the appropriate position by the rack guide housing 64, is increased. As a result, smooth sliding action of the rack shaft 16 can be maintained, and satisfactory meshing of the rack 32 with the pinion 31 can be sufficiently maintained. The vehicle steering device 10J can ensure a satisfactory steering sensation with no response lag in the action of the rack-and-pinion mechanism 15.

Furthermore, the direction of the offset of the annular groove 61Ia, relative to the center line Lg of the rack guide 61J, is the opposite direction away from the location where the pressing surface 61a of the rack guide 61J contacts the back surface 16a of the rack shaft 16. The groove depth from the center line Lg is greatest toward the location where the pressing surface 61a of the rack guide 61J contacts the back surface 16a of the rack shaft 16. Therefore, when the rack guide 61J is fitted in the supporting hole 64a, the amount of elastic deformation of the O ring 82 is greater in locations of greater groove depth. The O ring 82 has greater spring characteristics in locations of greater elastic deformation.

Moreover, since the O ring 82 is mounted as being offset in the rack guide 61J, when the rack guide 61J is fitted in the supporting hole 64a, the direction of fitting is easily confirmed with the naked eye. Therefore, the reliability of the rack guide 61J assembly is increased.

### Embodiment 12

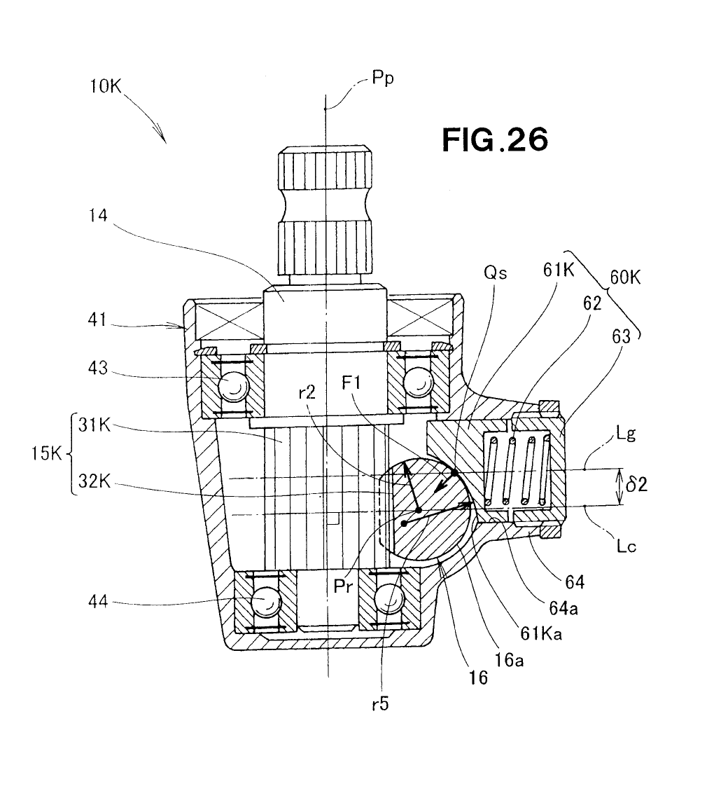

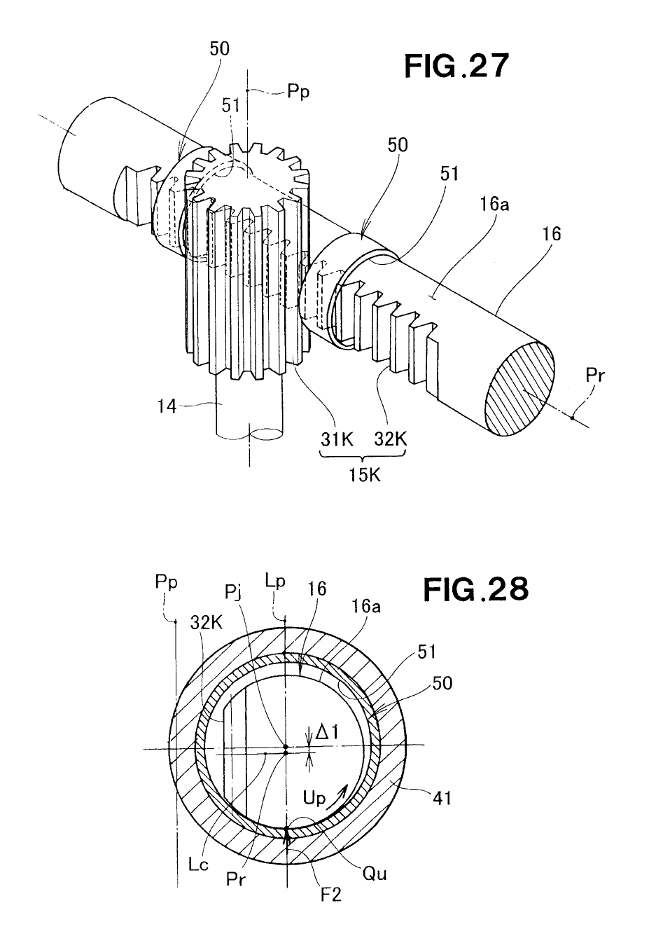

The vehicle steering device according to Embodiment 12 is described based on FIGS. 26 to 32. FIG. 26 corresponds to FIG. 3. FIG. 27 corresponds to FIG. 4. FIG. 28 corresponds to FIG. 5. In the vehicle steering device 10K of Embodiment 12, the rack-and-pinion mechanism 15 and the urging part 60 (the rack guide mechanism 60) of Embodiment 1 shown in FIGS. 3 to 5 are modified to the rack-and-pinion mechanism 15K and the urging part 60K (the rack guide mechanism 60K) shown in FIGS. 26 to 28. The configuration is otherwise the same as the configuration shown in FIGS. 1 to 7, and descriptions are therefore omitted.

The rack-and-pinion mechanism 15K of Embodiment 12 is composed of a pinion 31K and a rack 32K as shown in FIGS. 26 and 27. The pinion 31K and the rack 32K are equivalent to the pinion 31 and the rack 32 of Embodiment 1 shown in FIG. 3. The pinion 31K and the rack 32K of Embodiment 12 both have the configurations of “spur gears.” In other words, the pinion 31K has the configuration of a “spur gear” in which the tooth trace is parallel to the center line Pp of the pinion 31K. The rack 32K has the configuration of a “spur gear” in which the tooth trace is orthogonal to the rack shaft 16 (to the center line Pr of the rack shaft 16). In this case, the pinion shaft 14 and the rack shaft 16 are orthogonal to each other. In other words, the pinion shaft 14 is not inclined toward the longitudinal direction of the rack shaft 16.

Another possible configuration is one in which only the rack 32K is a “spur gear” and the pinion 31K which meshes with the rack 32K is a “helical gear” in which the tooth trace has a predetermined helix angle. In this case, the pinion shaft 14 is a so-called oblique shaft which is inclined toward the longitudinal direction of the rack shaft 16 by an angle equivalent to the helix angle of the “helical gear” of the pinion 31K. Therefore, the meshing configuration between the pinion 31K and the rack 32K is essentially the same as the configuration in which the pinion 31K and the rack 32K are both “spur gears.”

The rack guide mechanism 60K (the urging part 60K) of Embodiment 12 is composed of a rack guide 61K which touches the rack shaft 16 from the side opposite the rack 32K, a compression coil spring 62, and an adjusting bolt 63, as shown in FIG. 26.

The rack guide 61K is a perfectly circular columnar member centered on the center line Lg of the sliding direction. The center line Lg of the sliding direction is parallel to the pinion-orthogonal reference line Lc. In other words, the rack guide 61K is formed in a circular cross section whose reference is the center line Lg. The rack guide 61K and the compression coil spring 62 are accommodated in a rack guide housing 64. The rack guide housing 64, which is formed integrally in the housing 41, has a circular (perfectly circular) supporting hole 64a which can support the rack guide 61K so as to be capable of sliding along the center line Lg.

A pressing surface 61Ka of the rack guide 61K is formed in a substantially arcuate cross section extending along the back surface 16a of the rack shaft 16. This pressing surface 61Ka of the rack guide 61K is formed so as to be capable of contact only with any one surface of the back surface 16a of the rack shaft 16, relative to the pinion-orthogonal reference line Lc. For example, the pressing surface 61Ka of the rack guide 61K is capable of contact only with either the surface above or the surface below the horizontal pinion-orthogonal reference line Lc.

Specifically, the radius r5 of the arc of the pressing surface 61Ka of the rack guide 61K is designed to be greater than the radius r2 of the arc of the back surface 16a of the rack shaft 16 (r5>r2). The center of the radius r2 of the back surface 16a of the rack shaft 16 is positioned in the pinion-orthogonal reference line Lc. The center of the radius r5 of the arc of the pressing surface 61Ka of the rack guide 61K is offset either above or below the pinion-orthogonal reference line Lc, i.e., in the face width direction (the tooth trace direction) of the rack 32K. As a result, the pressing surface 61Ka of the rack guide 61K contacts only the surface of the back surface 16a of the rack shaft 16 that is either above or below the horizontal pinion-orthogonal reference line Lc. In FIG. 26, the pressing surface 61Ka of the rack guide 61K contacts only the surface of the back surface 16a of the rack shaft 16 that is above the pinion-orthogonal reference line Lc.

Because of the relationship “r5>r2” as described above, the pressing surface 61Ka of the rack guide 61K contacts the back surface 16a of the rack shaft 16 at only one contact region Qs. The contact region Qs of the pressing surface 61Ka of the rack guide 61K on the back surface 16a of the rack shaft 16 extends in a straight line in the longitudinal direction of the rack shaft 16, and the contact region Qs is positioned so that the size of the rack guide 61K reaches a maximum in the longitudinal direction of the rack shaft 16. More specifically, the center line Lg of the rack guide 61K in the sliding direction and the center line Lg of the compression coil spring 62 are offset from the pinion-orthogonal reference line Lc by an offset amount 62 in the direction in which the pressing surface 61Ka of the rack guide 61K contacts the back surface 16a of the rack shaft 16. In other words, the center of the pressing surface 61Ka of the rack guide 61K is offset from the center of the rack shaft 16 in the face width direction of the rack 32K.

Next, the action of Embodiment 12 is described. The rack 32K is a “spur gear” as shown in FIGS. 26 and 27. The pinion 31K which meshes with the rack 32K is also a “spur gear.” Alternatively, by making the pinion 31K a “helical gear” and inclining the pinion shaft 14 toward the longitudinal direction of the rack shaft 16 by an angle equivalent to the helix angle of the “helical gear,” a configuration essentially the same as that of a “spur gear” can be achieved. Thus, the meshing configuration between the pinion 31K and the rack 32K is essentially the same as the configuration when the pinion 31K and the rack 32K are both “spur gears.” Therefore, the direction of the tooth trace of the pinion 31K matches the direction of the tooth trace of the rack 32K.

Consequently, when an external force (including vibration) in the direction of the tooth trace of the rack 32K acts on the rack 32K, the rack 32K readily displaces in the direction of the “tooth trace” (the face width direction). For example, when vibration in the direction of the tooth trace of the rack 32K is transmitted from the exterior to the rack 32K, the rack 32K may vibrate in the direction of the tooth trace. Therefore, vibration in the direction of the tooth trace of the rack 32K is not readily converted to vibration in the rotational direction of the pinion 31K and transmitted to the steering wheel 11 (FIG. 1). As a result, the driver experiences a greater steering sensation. The “spur gear” rack 32K also functions in a direction of regulating the vibration in the rotational direction of the pinion 31K. Therefore, the vibration in the rotational direction of the pinion 31K is not readily transmitted to the steering wheel 11. As a result, the driver experiences a greater steering sensation.

When the steering device is not being steered, there is no reaction force that is transmitted from the steered wheels 21, 21 to the rack shaft 16 via the tie rods 18, 18 during steering, as shown in FIG. 7(a). Therefore, the rack guide 61K contacts the back surface 16a of the rack shaft 16 at only one contact region Qs as shown in FIG. 26, the rack shaft 16 is pressed against the pinion 31K by the urging force F1 of the compression coil spring 62, and as shown in FIGS. 27 and 28, the back surface 16a of the rack shaft 16 is pressed against the rack support parts 50, 50 (precompression is applied).

The cross-sectional center Pr (the center line Pr) of the rack shaft 16 is offset relative to the cross-sectional center Pj (the center line Pj) of the two bearings 50, 50 by an offset amount Δ1 in the face width direction of the rack 32K along the center line Pp of the pinion 31K, as shown in FIG. 28. Therefore, the rack shaft 16 has a contact point Qu on the line of action connecting the cross-sectional center Pj of the bearings 50, 50 and the cross-sectional center Pr of the rack shaft 16, i.e., on the pinion-parallel reference line Lp. This contact point Qu is a point where the back surface 16a of the rack shaft 16 is in contact with the support holes 51, 51 of the bearings 50, 50. As a result, a reaction force F2 occurs in the bearings 50, 50. The bearings 50, 50 come to support the back surface 16a of the rack shaft 16. Thus, the back surface 16a of the rack shaft 16 is supported so as to be capable of sliding in the longitudinal direction by three points: the pinion 31 and the two bearings 50, 50.

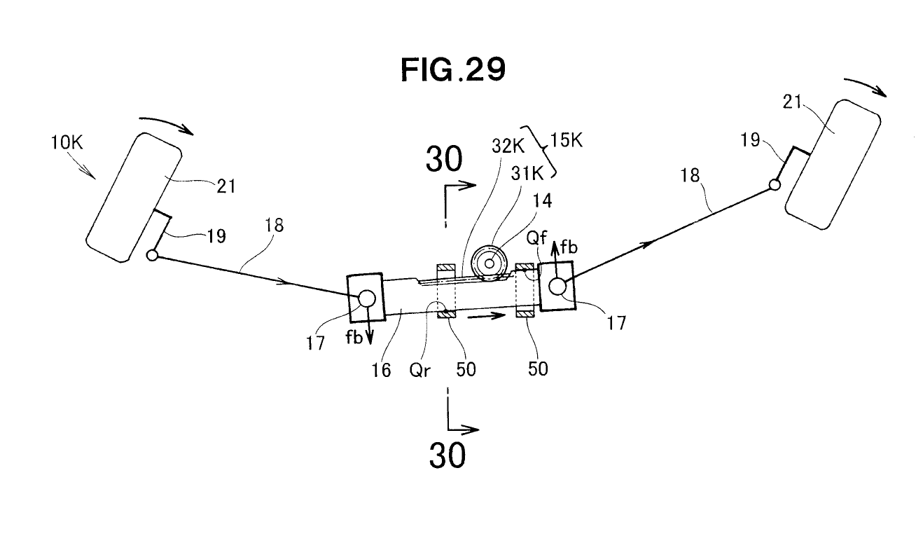

When the steering device is then steered, the following occurs. FIG. 29 schematically shows the steering device 10K in a plan view in a state in which the rack 32K is slidably displaced to the right due to the steering device 10K being steered to the right. The tie rods 18, 18 are inclined relative to the rack shaft 16 at an angle of inclination φ (FIG. 7(a)) in the front-back direction of the vehicle. Therefore, when the rack shaft 16 is slidably displaced in the vehicle width direction, forces fb, fb (bending forces fb, fb) act on the rack shaft 16 in a direction perpendicular to the rack shaft 16.

When the steering device 10K is steered to the right, for example, a road surface reaction force occurs according to the frictional force between the road surface and the steered wheels 21, 21. This road surface reaction force acts from the steered wheels 21, 21, through the tie rods 18, 18, to the rack shaft 16. Therefore, a bending force fb toward the rear of the vehicle acts on the left end of the rack shaft 16, and a bending force fb toward the front of the vehicle acts on the right end of the rack shaft 16.

When this bending force fb is small, the back surface 16a of the rack shaft 16 is supported so as to be capable of sliding in the longitudinal direction by three points: the pinion 31K and the two bearings 50, 50. The frictional force when the rack shaft 16 slides is only a comparatively small frictional force corresponding to the urging force F1 of the rack guide 61K pressing on the rack shaft 16, shown in FIG. 26. Consequently, the steering device 10K has the favorable friction characteristic of small frictional force.

Even when the bending force fb has exceeded the frictional force corresponding to the urging force F1, it is still preferable that the back surface 16a of the rack shaft 16 can be reliably supported by the bearings 50, 50 so as to be capable of sliding in the longitudinal direction. In other words, the back surface 16a of the rack shaft 16 is supported and the rack 32K is prevented as much as possible from being affected by the reaction force. To achieve this, when the bending force fb is large in Embodiment 12, a form of statically indeterminate support is formed of three points: the meshing point between the pinion 31K and the rack 32K, and the points of support by the bearings 50, 50.

To go into detail, the rack shaft 16, being subjected to the large bending force fb, undergoes a front-back swinging motion in the direction in which the left end of the rack shaft 16 retreats and the right end of the rack shaft 16 advances (the counterclockwise direction in FIG. 29), the support point being the meshing point between the pinion 31K and the rack 32K. In other words, while the right end of the rack shaft 16 slides in the vehicle width direction, the left end of the rack shaft 16 retreats. At this time, the left region of the rack shaft 16 in the state shown in FIG. 28 retreats while gradually rising rearward and upward (in the direction of arrow Up) along the surface of the support hole 51 of the left bearing 50. The so-called “gradually rising amount,” whereby the rack shaft 16 gradually rises, increases as the bending force fb increases.

As described above, the meshing configuration between the pinion 31K and the rack 32K is essentially the same as the configuration when both the pinion 31K and the rack 32K are “spur gears.” Therefore, the direction of the tooth trace of the pinion 31K matches the direction of the tooth trace of the rack 32K. Consequently, when external force in the gradually rising direction, i.e., external force in the direction of the tooth trace of the rack 32K acts on the rack 32K, the rack 32K is readily displaced in the direction of the “tooth trace” (in the face width direction). Thus, since the rack 32K is a “spur gear,” the gradually rising motion of the rack shaft 16 occurs easily.

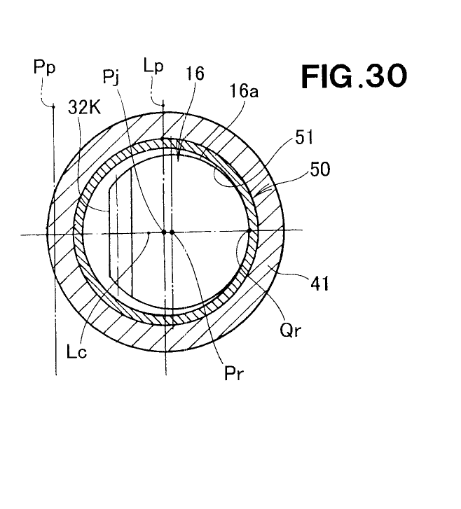

The results of the rack shaft 16 retreating while gradually rising are shown in FIG. 30. FIG. 30 shows a state in which due to the gradual rising of the rack shaft 16, the contact point Qr where the back surface 16a of the rack shaft 16 is in contact with the support holes 51, 51 of the bearings 50, 50 has come to be positioned on the pinion-orthogonal reference line Lc. Since the rear end of the back surface 16a of the rack shaft 16 is in contact with the rear surface of the support hole 51 of the left bearing 50, the bearing 50 can sufficiently support the rack shaft 16 and can also sufficiently and reliably bear the reaction force.

As described above, when a large reaction force is applied to the rack shaft 16, the bending force fb increases according to the extent of the reaction force. According to this bending force fb, the rack shaft 16 gradually rises upward and backward while sliding along the surface of the support holes 51, 51 of the bearings 50, 50. In other words, a statically indeterminate support structure is configured in which the support position where the rack shaft 16 is supported by the bearings 50, 50 (the rack support parts 50, 50) changes according to the extent of the reaction force applied to the rack shaft 16. The bearings 50, 50 can firmly support the back surface 16a of the rack shaft 16 at the location most appropriate for the extent of the reaction force, e.g., at the contact point Qr. As a result, the rack shaft 16 is supported at three points: the meshing point between the pinion 31K and the rack 32K, and the points of support by the bearings 50, 50. Moreover, since the bearings 50, 50 support the back surface 16a of the rack shaft 16 at the location most appropriate for the extent of the reaction force, durability is high.

When the rack 32K is a “helical gear,” the teeth are formed at an incline relative to the center line Pr of the rack shaft 16. Therefore, with any cross section orthogonal to the center line Pr of the rack shaft 16, part of the cross section will contain the teeth of the rack 32K. In Embodiment 12, since the rack 32K is a “spur gear,” when cross sections are taken one after another of the rack 32K along the center line Pr of the rack shaft 16, the tooth tip regions and tooth base regions repeat. In other words, depending on the cross section, there are regions where there is only tooth base, and is no tooth tip. The secondary moment of a cross section of a region with only tooth base and without tooth tip is less than the secondary moment of cross sections of other regions. Consequently, the rack shaft 16 as a whole flexes comparatively readily, more so than when the rack 32K is a “helical gear.” Moreover, when an external force (including vibration) in the direction of the tooth trace of the rack 32K acts on the rack 32K as described above, the rack 32K is readily displaced in the direction of the “tooth trace.” Consequently, the back surface of the rack shaft 16 is reliably supported so as to be capable of sliding in the longitudinal direction by three points: the pinion 31K and the two rack support parts 50, 50.

Thus, even when a large reaction force is applied, the rack shaft 16 is sufficiently supported by three points: the left and right bearings 50, 50 and the pinion 31K.

Since the displacement of the right end of the rack shaft 16 is the longitudinal opposite of the displacement of the left end of the rack shaft 16, a description thereof is omitted. The rack shaft 16 preferably has the configuration of the rack shaft 16E of Embodiment 6 shown in FIGS. 14 and 15. The reason for this is because when the rack shaft 16E has drawn near to the pinion 31K, at least one of the two rack-adjacent convex parts 16Ec, 16Ed comes in contact first with the bearings 50, 50, and the rack 32K therefore does not come in contact with the bearings 50, 50.

Furthermore, since the overall length of the rack shaft 16 is short as described above, the pinion 31K can be positioned in the widthwise center of the vehicle. In contrast to this, the steering wheel 11 can then be positioned off-center to the left or right. In other words, the pinion shaft 14 will be inclined toward the longitudinal direction of the rack shaft 16. The inclined direction of the pinion shaft 14 will be reversed between the right-hand drive and the left-hand drive. However, since the rack 32K is a “spur gear,” the inclined direction can be the same with both right-hand drive and the left-hand drive. It is easy to manage the quality of the steering device 10K, and productivity increases.

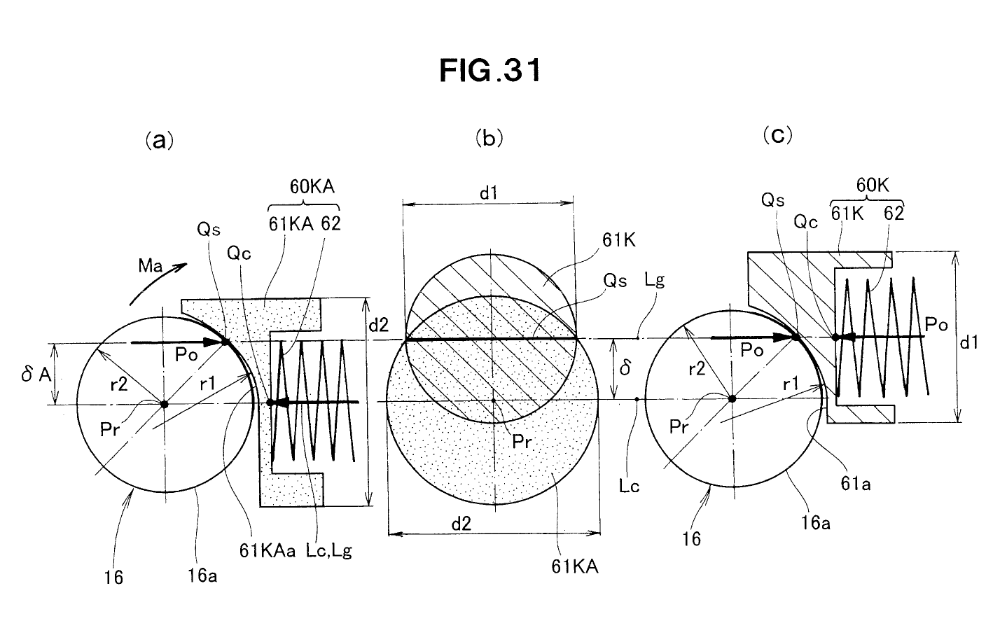

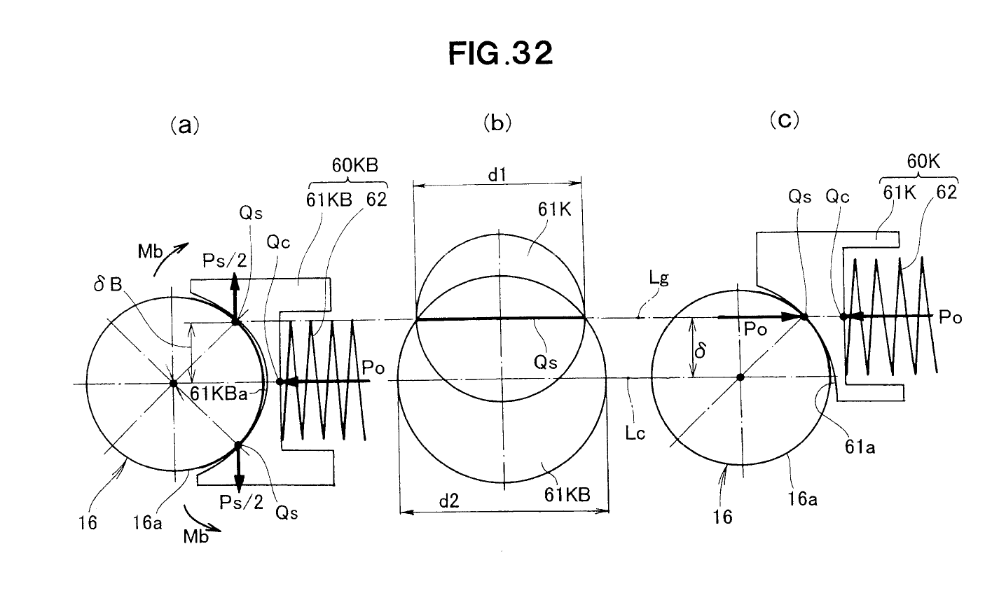

Next, FIGS. 31 and 32 are used as references to describe the action caused by the center line Lg of the rack guide 61K being offset from the pinion-orthogonal reference line Lc in the steering device 10K according to Embodiment 12 shown in FIG. 26. FIG. 32(a) shows an example in which the center line Lg of the rack guide 61K is not offset from the pinion-orthogonal reference line Lc. FIG. 32(b) depicts the configuration of the rack guide 61K of Embodiment 12 shown in FIG. 32(c) and the rack guide 61KA shown in FIG. 32(a) as seen from the sliding directions of the rack guides 61K, 61KA.

The basic configuration of the urging part 60KA shown in FIG. 31(a) is essentially the same as the urging part 60K of the embodiment shown in FIG. 31(c), and is composed of a rack guide 61KA and a compression coil spring 62. A support surface 61KAa of the rack guide 60KA is in contact with only one side of the back surface 16a of the rack shaft 16 relative to the pinion-orthogonal reference line Lc, as shown in FIG. 31(a). Nevertheless, the center line Lg of the sliding direction of the rack guide 61KA matches the pinion-orthogonal reference line Lc. Therefore, there is a wide useless range in which the support surface 61KAa of the rack guide 61KA does not contact the back surface 16a of the rack shaft 16. The outside diameter d2 of the rack guide 61KA must be increased proportionately.

Furthermore, an urging point Qc of the compression coil spring 62 (the center of the compression coil spring 62) is positioned on the pinion-orthogonal reference line Lc, as shown in FIG. 31(a). The distance from the pinion-orthogonal reference line Lc to the contact region Qs is δA. Therefore, when the contact region Qs of the rack guide 61KA pushes the rack shaft 16 due to the urging force of the compression coil spring 62, a reaction force Po is applied to the contact region Qs from the rack shaft 16. This reaction force Po is equal to the urging force of the compression coil spring 62. Consequently, a moment Ma occurs in the rack guide 61KA (Ma=δA×Po).

The rack guide 61 is slidably fitted with the supporting hole 64a of the rack guide housing 64, as shown in FIG. 3. A “twisting force” (an unbalanced load) corresponding to the moment Ma acts between the rack guide 61 and the wall surface of the supporting hole 64a. Therefore, frictional force of a value obtained by multiplying the friction coefficient by this “twisting force” occurs between the rack guide 61 and the wall surface of the supporting hole 64a. This frictional force is drag that impedes the sliding motion of the rack guide 61. Such drag is undesirable as it increases the tendency of the rack guide 61 to mimic the vibration of the rack shaft 16. Moreover, the occurrence of uneven abrasion between the rack guide 61 and the wall surface of the supporting hole 64a may cause the rack guide 61 to rattle, and there is therefore room for improvement in terms of increasing the durability of the urging part 60.

In contrast to this, the center line Lg of the sliding direction of the rack guide is offset from the pinion-orthogonal reference line Lc in the direction in which the support surface 61a of the rack guide 61K comes in contact with the back surface 16a of the rack shaft 16, as shown in FIG. 31(c). Therefore, the useless range in which the support surface 61a does not contact the back surface 16a of the rack shaft 16 can be narrowed. Since the outside diameter d1 of the rack guide 61K can be reduced proportionately, as a result, the rack guide 61K can be reduced in weight. Thus, the range in which the support surface 61a of the rack guide 61K is capable of contacting the back surface 16a of the rack shaft 16 can be ensured, and the size and weight of the rack guide 61 can be reduced.

Taking into consideration that the rack guide 61K having considerable mass and the compression coil spring 62 having a predetermined spring constant make up a vibration system, the characteristic frequency (the resonance frequency) of this vibration system increases due to the rack guide 61K being reduced in weight. Therefore, since the rack guide 61K has a greater tendency to mimic the vibration of the rack shaft 16, a satisfactory meshing state of the rack 32 with the pinion 31 (FIG. 3) can be sufficiently maintained. Consequently, the friction characteristics between the pinion 31 and the rack 32 are satisfactory, the rack-and-pinion steering device 10K (FIG. 26) can therefore be steered more smoothly, and as a result, the steering sensation can be increased. Moreover, the strength and durability of the rack-and-pinion mechanism 15 can be increased by ensuring that the satisfactory meshing state between the pinion 31 and the rack 32 can be maintained.

Furthermore, the contact region Qs of the support surface 61a of the rack guide 61K with the back surface 16a of the rack shaft 16 extends in a straight line in the longitudinal direction of the rack shaft 16, and the contact region Qs is positioned so that the size of the rack guide 61K reaches a maximum (the value of the outside diameter d1) in the longitudinal direction of the rack shaft 16, as shown in FIG. 31(b). In other words, the rack guide 61K is formed in a circular cross section whose reference is the center line Lg in the sliding direction of the rack guide 61K, and the contact region Qs is positioned on the center line Lg. Consequently, the contact region Qs of the support surface 61a of the rack guide 61K on the back surface 16a of the rack shaft 16 extends in a straight line in the longitudinal direction of the rack shaft 16, and the length of this linear extension, being equal to the outside diameter d1 of the rack guide 61K, is at a maximum. Therefore, the useless area in which the support surface 61a of the rack guide 61K is not in contact with the back surface 16a of the rack shaft 16 is narrower than in the case in which the center line Lg in the sliding direction of the rack guide 61K matches the pinion-orthogonal reference line Lc (FIG. 31(a)). Consequently, the size (the outside diameter d1) of the rack guide 61K can be reduced, and as a result, the rack guide 61K can therefore be reduced in weight.

Furthermore, the urging point Qc of the compression coil spring 62 matches the contact region Qs as shown in FIG. 31(c). Therefore, there is no moment caused by the reaction force Po applied to the contact region Qs from the rack shaft 16. Consequently, the rack guide 61K can be made more likely to mimic the vibration of the rack shaft 16. Moreover, the durability of the urging part 60K can be increased. For example, since the moment does not occur, excessive “twisting force” (unbalanced load) caused by this moment does not act on the rack guide 61K, the compression coil spring 62, or the adjusting bolt 63 (FIG. 3). Therefore, there is no increase of the gap between the rack guide 61K and the adjusting bolt 63 which is caused by deformation (settling) or wear in the bearing surfaces (the support surface 61a and the spring-receiving surface) of the rack guide 61K and the bearing surface (the spring-receiving surface) of the adjusting bolt 63.

Furthermore, since the center line Lg in the sliding direction of the rack guide 61K is offset from the pinion-orthogonal reference line Lc in the direction in which the support surface 61a of the rack guide 61K contacts the back surface 16a of the rack shaft 16, there is no danger of the rack guide 61K being assembled facing the wrong direction on the back surface 16a of the rack shaft 16. Therefore, the productivity of the vehicle steering device 10K increases. For example, when the rack guide 61K is assembled upside-down on the back surface 16a of the rack shaft 16, the support surface 61a of the rack guide 61K is separated from the back surface 16a of the rack shaft 16. Therefore, the operator can easily perceive with the naked eye that the rack guide 61K is facing the wrong direction.

Next is a description of the action caused by the contact region Qs of the support surface 61KBa (or 61a) of the rack guide 61KB (or 61K) being provided to only one side of the pinion-orthogonal reference line Lc. FIG. 32(a) shows a case in which the center line Lg of the rack guide 61KB is not offset from the pinion-orthogonal reference line Lc. FIG. 32(b) depicts the configuration of the rack guide 61K of the embodiment shown in FIG. 32(c) and the rack guide 61KB shown in FIG. 32(b) as seen from the sliding direction of the rack guides 61K, 61KB.

The urging part 60KB is composed of the rack guide 61KB and the compression coil spring 62, as shown in FIGS. 32(a) and 32(b). The center line Lg in the sliding direction of the rack guide 61KB matches the pinion-orthogonal reference line Lc. Moreover, the support surface 61KBa of the rack guide 61KB is in contact with both sides of the back surface 16a of the rack shaft 16 relative to the pinion-orthogonal reference line Lc. In other words, the contact region Qs of the support surface 61KBa of the rack guide 61KB relative to the pinion-orthogonal reference line Lc is in two locations.

The urging point Qc of the compression coil spring 62 (the center of the compression coil spring 62) is positioned on the pinion-orthogonal reference line Lc, as shown in FIG. 32(a). The distances from the pinion-orthogonal reference line Lc to the contact regions Qs, Qs are δB, δB. Therefore, when the contact regions Qs, Qs of the rack guide 61KB push the rack shaft 16 due to the urging force of the compression coil spring 62, respective reaction forces Po/2, Po/2 are applied to the contact regions Qs, Qs from the rack shaft 16. Each reaction force Po/2 is half of the urging force Po of the compression coil spring 62. Consequently, moments Mb, Mb occur in the rack guide 61KB on both sides of the pinion-orthogonal reference line Lc (Mb=δB×Po/2).

Furthermore, when the left and right steered wheels 21, 21 are steered as shown in FIGS. 7(a) and 7(b), the rack shaft 16 receives thrust (a force which causes the rack shaft 16 to be slidably displaced in the vehicle width direction) from the steered wheels 21, 21. Depending on the pressure angle of the rack 32, the rack 32 converts this thrust into reaction force in the direction of the pinion-orthogonal reference line Lc. The reaction forces Po/2, Po/2 applied to the contact regions Qs, Qs increase further in proportion to this reaction force.

Therefore, taking the moments Mb, Mb into account, a material of very high strength, e.g., steel, must be used for the rack guide 61KB.

In contrast to this, the support surface 61a of the rack guide 61K is in contact with only one side of the back surface 16a of the rack shaft 16 relative to the pinion-orthogonal reference line Lc, as shown in FIG. 32(c). Moreover, the center line Lg in the sliding direction of the rack guide 61K is offset from the pinion-orthogonal reference line Lc in the direction in which the support surface 61a of the rack guide 61K contacts the back surface 16a of the rack shaft 16. Furthermore, the urging point Qc of the compression coil spring 62 matches the contact region Qs. Therefore, there is no moment caused by the reaction force Po applied to the contact region Qs from the rack shaft 16. Consequently, a material whose strength is lower in proportion to the absence of the moment, e.g., the resin described above, can be used for the rack guide 61K.

By using a resinous rack guide 61K, the rack guide 61K, which has considerable mass, can be reduced in weight. Taking into consideration that the rack guide 61K having considerable mass and the compression coil spring 62 make up a vibration system, the characteristic frequency of this vibration system further increases due to the rack guide 61K being reduced in weight. Therefore, since the rack guide 61K has an even greater tendency to mimic the vibration of the rack shaft 16, a satisfactory meshing state of the rack 32 with the pinion 31 (FIG. 6) can be more sufficiently maintained. Consequently, the friction characteristics between the pinion 31 and the rack 32 are satisfactory, the rack-and-pinion steering device 10 (FIG. 1) can therefore be steered more smoothly, and as a result, the steering sensation can be increased.

It is most preferable that the shape of the rack guide 61K and the offset amount δ relative to the pinion-orthogonal reference line Lc be set so that in the rack guide 61K, the contact region Qs of the support surface 61a of the rack guide 61K on the back surface 16a of the rack shaft 16 extends in a straight line in the longitudinal direction of the rack shaft 16 and the size of the rack guide 61K reaches a maximum (the length of the contact region Qs extending in a straight line reaches a maximum) in the longitudinal direction of the rack shaft 16.

For example, the shape of the end surface of the rack guide 61K as seen from the side of the support surface 61a of the rack guide 61K (the end surface that faces the rack shaft 16), i.e., the cross-sectional shape of the rack guide 61K as seen from the sliding direction (as seen along the center line Lg of the sliding direction), can be set to an elliptical cross section or a polygonal (square, triangular, and so forth) cross section relative to the center line Pr of the rack shaft 16, rather than a perfectly circular cross section.

The shape of the support surface 61a of the rack guide 61K can be a flat surface against the back surface 16a of the rack shaft 16, the basis of the flat surface being a “tangent passing through the contact region Qs,” rather than the substantially arcuate cross section shown in FIG. 3.

According to Embodiment 12 the same actions and effects as those of Embodiment 1 are also exhibited.

### Embodiment 13

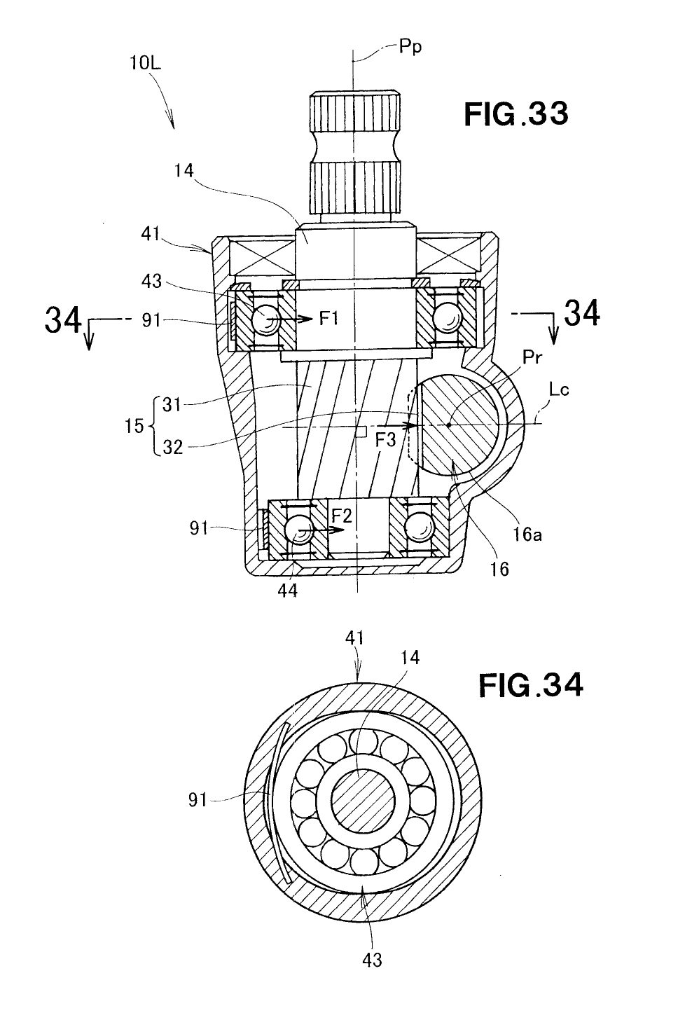

Next, the vehicle steering device according to Embodiment 13 is described based on FIGS. 33 to 36. In the vehicle steering device 10L of Embodiment 13, the urging part 60 (the rack guide mechanism 60) shown in FIG. 3 is modified to the urging parts 91, 91 shown in FIGS. 33 to 36. The configuration is otherwise the same as the configuration shown in FIGS. 1 to 7, and descriptions are therefore omitted.

Specifically, the urging parts 91, 91 of Embodiment 13 urge the pinion 31 in a direction of meshing with the rack 32. These two urging parts 91, 91 are configured from ribbon-shaped “plate springs” provided between the housing 41 and the external peripheral surfaces of two bearings 43, 44.

The plate springs 91, 91 are made to flex into arches in the plate thickness direction and both ends are fitted into the housing 41, whereby the plate springs 91, 91 are fastened to the housing 41. Attached to the housing 41, the plate springs 91, 91 flex into arcuate shapes so as to separately envelop the external peripheral surfaces of the two bearings 43, 44. Therefore, the plate springs 91, 91 urge the pinion 31 in a direction of meshing with the rack 32, via the bearings 43, 44 and the pinion shaft 14. Therefore, a satisfactory meshing state between the pinion 31 and the rack 32 can be maintained.

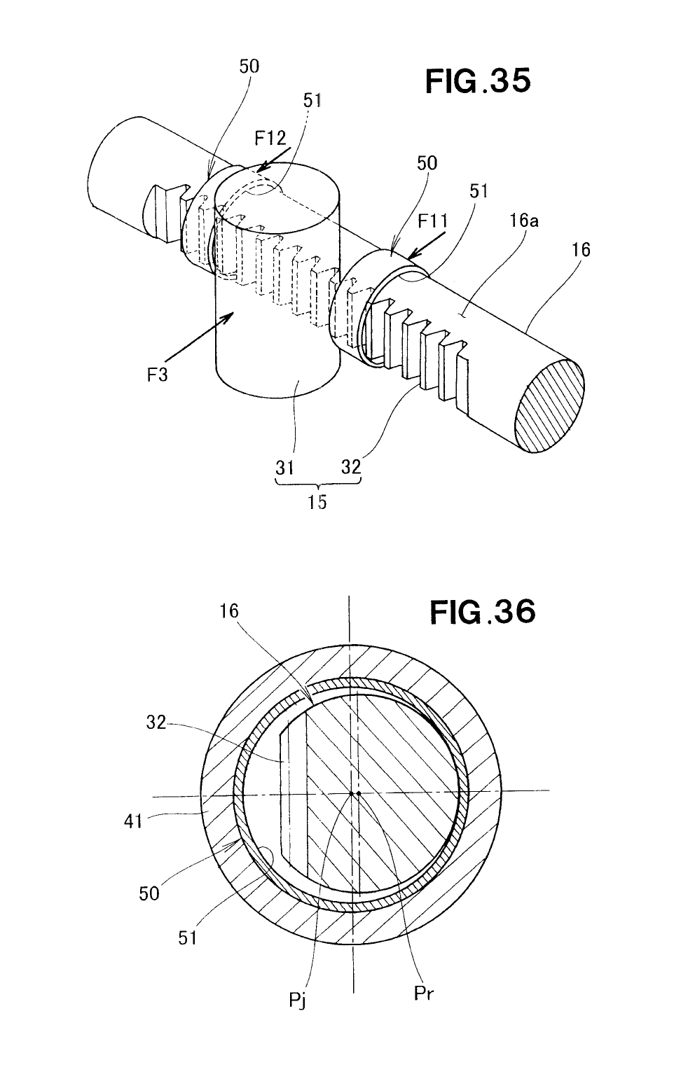

The resultant force F3 of the urging forces F1, F2 of the plate springs 91, 91 is transmitted from the pinion 31 to the rack shaft 16 via the rack 32, as shown in FIG. 35. At this time, respective reaction forces F11, F12 occur in the two bearings 50, 50 supporting the back surface 16a of the rack shaft 16, as shown in FIG. 35. Thus, the back surface 16a of the rack shaft 16 is reliably supported so as to be capable of sliding in the longitudinal direction by three points: the pinion 31 and the two bearings 50, 50. This rack shaft support configuration is equivalent to a support configuration in so-called balanced conditions in which “a beam juts out from both sides of two fulcra, and a concentrated load (the resultant force F3) acts in the longitudinal center of this beam.” Moreover, the rack 32 itself is not supported by the bearings 50, 50. Therefore, there is no need to provide separate support members for supporting the rack shaft 16, and the support configuration can be simplified.

In Embodiment 13, the pinion 31 and the rack 32 have the configurations of “helical gears,” but also possible is a configuration in which the rack 32 is a “spur gear” orthogonal to the rack shaft 16, the pinion 31 is a “helical gear,” and the pinion shaft 14 is inclined in the longitudinal direction of the rack shaft 16. Furthermore, the pinion 31 and the rack 32 can both be “spur gears.”

The vehicle rack-and-pinion steering devices 10 to 10L of the present invention are suitable for installation in compact cars that are small in width.

Obviously, various minor changes and modifications of the present invention are possible in light of the above teaching. It is therefore to be understood that within the scope of the appended claims the invention may be practiced otherwise than as specifically described.

What is claimed is:

1. A vehicle steering device in which a steering torque generated by steering a steering wheel is transmitted from the steering wheel to steered wheels via a rack-and-pinion mechanism, the vehicle steering device comprising:
a rack shaft in which a rack of the rack-and-pinion mechanism is formed;
two rack support parts positioned one on each side of a longitudinal direction of the rack shaft relative to a position of a pinion of the rack-and-pinion mechanism; and
an urging part positioned between the two rack support parts,
wherein the two rack support parts are positioned closely to each other so as to support only a back surface of a region where the rack is formed in the rack shaft which is positioned in a neutral steering position, the back surface being supported to be capable of sliding in a longitudinal direction of the rack shaft, and
the urging direction of the urging part is set so that the rack shaft is urged to at least a region other than the region where the rack is formed.

2. The steering device of claim 1, wherein
the urging part comprises:
a rack guide for supporting the back surface of the region of the rack shaft where the rack is formed, the back surface being supported to be capable of sliding in the longitudinal direction of the rack shaft; and
a compression coil spring for urging the rack guide toward the back surface, and
wherein the rack guide has a pressing surface for pressing the back surface, and
the pressing surface is formed to be capable of contact with only one of any side of the surfaces of the back surface relative to a pinion-orthogonal reference line which is orthogonal to a center line of the rack shaft and orthogonal to a center line of the pinion.

3. The steering device of claim 2, wherein
at least the back surface of the rack shaft is formed in a substantially arcuate cross section;
the pressing surface is formed in a substantially arcuate cross section along the back surface;
a radius of an arc of the pressing surface is set to be greater than a radius of an arc of the back surface; and
the center of the pressing surface is offset from the center line of the rack shaft in a face width direction of the rack.

4. The steering device of claim 1, wherein
the urging part comprises:
a rack guide for supporting the back surface of the region of the rack shaft where the rack is formed, the back surface being supported to be capable of sliding in the longitudinal direction of the rack shaft; and
a compression coil spring for urging the rack guide toward the back surface,
wherein a center line of the rack guide and a center line of the compression coil spring are inclined in an axial direction of the pinion relative to a pinion-orthogonal reference line which is orthogonal to a center line of the rack shaft and orthogonal to a center line of the pinion.

5. The steering device of claim 1, wherein
the two rack support parts are comprised of cylindrical bearings, and
a center line of the rack shaft is offset from a center line of the bearings in a direction away from the pinion and along a center line of the pinion.

6. The steering device of claim 4, wherein
a straight line orthogonal to the center line of the rack shaft and parallel to the center line of the pinion is defined as a pinion-parallel reference line;
the two rack support parts are comprised of cylindrical bearings;
two rack-opposite convex parts capable of being supported by the two bearings are formed on a same periphery of an external peripheral surface of the rack shaft; and
the two rack-opposite convex parts are positioned on the side of the pinion-parallel reference line that is opposite of the rack, and are positioned on both sides of the pinion-orthogonal reference line.

7. The steering device of claim 6, wherein
two rack-adjacent convex parts capable of being supported by the two bearings are formed on the same periphery of the external peripheral surface of the rack shaft; and
the two rack-adjacent convex parts are positioned between the pinion-parallel reference line and the rack, and are positioned on both sides of the pinion-orthogonal reference line.

8. The steering device of claim 7, wherein
the rack shaft is formed from a hollow material; and
the two rack-opposite convex parts and the two rack-adjacent convex parts comprise portions formed by extruding the hollow member radially outward from inside.

9. The steering device of claim 2, wherein
the rack guide further comprises a swing regulator for regulating swinging about the pinion-orthogonal reference line.

10. The steering device of claim 9, wherein
the rack guide comprises a circular member centered on the pinion-orthogonal reference line and is accommodated in a rack guide housing;
the rack guide housing has a circular supporting hole capable of slidably supporting the rack guide along the pinion-orthogonal reference line; and
the swing regulator comprises at least two convex parts formed in a circumferential direction of an external peripheral surface of the rack guide and capable of contact with an internal peripheral surface of the supporting hole.

11. The steering device of claim 9, wherein
the rack guide comprises a circular member centered on the pinion-orthogonal reference line and is accommodated in a rack guide housing;
the rack guide housing has a circular supporting hole capable of slidably supporting the rack guide along the pinion-orthogonal reference line; and
the swing regulator comprises a viscoelastic packed bed, including a liquid packing, which is filled into a gap between an external peripheral surface of the rack guide and an internal peripheral surface of the supporting hole.

12. The steering device of claim 9, wherein
the rack guide comprises a circular member centered on the pinion-orthogonal reference line, the rack guide being provided with an annular groove for mounting an O ring on an external peripheral surface, and being accommodated in a rack guide housing;
the rack guide housing has a circular supporting hole capable of slidably supporting the rack guide along the pinion-orthogonal reference line;
the swing regulator comprises the O ring mounted in the annular groove; and
an external peripheral surface of the O ring is in contact throughout an entire periphery thereof with an internal peripheral surface of the supporting hole.

13. The steering device of claim 12, wherein
the annular groove has a center offset from a center line of the rack guide.

14. The steering device of claim 1, wherein
the urging part urges the pinion in a direction of meshing with the rack.

15. The steering device of claim 1, wherein
the rack comprises a spur gear having a tooth trace orthogonal to the rack shaft.

16. The steering device of claim 1, wherein
the urging part comprises:
a rack guide which is capable of sliding along a pinion-orthogonal reference line orthogonal to a center line of the rack shaft and orthogonal to a center line of the pinion, and which supports the back surface of the region of the rack shaft where the rack is formed, the back surface being supported to be capable of sliding in an longitudinal direction; and
a compression coil spring for urging the rack guide toward the back surface,
wherein the rack guide has a support surface for supporting the back surface;
the support surface is formed to be capable of contact with only one side of the back surface relative to the pinion-orthogonal reference line; and
a center line in the sliding direction of the rack guide is offset from the pinion-orthogonal reference line in the direction in which the support surface makes contact with the back surface.

17. The steering device of claim 16, wherein
a contact region of the support surface on the back surface extends in a straight line in the longitudinal direction of the rack shaft, and is positioned so that a size of the rack guide reaches a maximum in the longitudinal direction of the rack shaft.

18. The steering device of claim 17, wherein
the rack guide is formed to have a circular cross section whose reference is a center line in the sliding direction of the rack guide, and the contact region is positioned on the center line.
